(19) United States
(12) Patent Application Publication
(10) Pub. No.: US 2011/0067895 A1
(43) Pub. Date: Mar. 24, 2011

(54) TOOL, INFORMATION PROCESSING UNIT, TERMINAL UNIT, AND MANAGEMENT SYSTEM

(75) Inventors: Nobuyuki Nobe, Tokyo (JP); Michiaki Adachi, Tokyo (JP); Tsutomu Tsushima, Tokyo (JP)

(73) Assignee: Max Co. Ltd, Tokyo (JP)

(21) Appl. No.: 12/993,280

(22) PCT Filed: May 19, 2009
(86) PCT No.: PCT/JP2009/059213

§ 371 Date: Nov. 18, 2010

(30) Foreign Application Priority Data
May 20, 2008 (JP) 2008132313
May 20, 2008 (JP) 2008132314

(51) Int. Cl. B25B 33/00; G08B 21/00

(52) U.S. Cl. 173/20; 340/680

(57) ABSTRACT

A sensor part detects an actual driving signal in the driving time by a pneumatic tool. A control part, based on the detected actual driving signal, makes an addition to the actual driving number which has already stored in a memory part to updates the actual driving number, and compares the updated accumulative actual driving number with the previously set basic maintenance number. As a result of the comparison, in case the accumulative actual driving number exceeds the basic maintenance number, it is determined that maintenance is necessary for the pneumatic tool. A light emitting part emits the light and blinks by an instruction from the control part, thereby to warn a user that the pneumatic tool is into the maintenance time. Hereby, the user can grasp the maintenance time of the tool surely and exactly.

### TECHNICAL FIELD

The present invention relates to a tool, and particularly to a tool which determines maintenance time of the tool by detecting the current-carrying time of the tool or the number of actual driving of the tool, and notifies, when it has been determined that maintenance is necessary, a user about its fact.

The invention relates to an information processing unit, and particularly to an information processing unit which receives by a light receiving part a light emission signal based on maintenance information which is emitted from a light emitting part of a tool, and displays the maintenance information in a display part.

The invention relates further to a terminal unit and a management system, and particularly to a terminal unit and a management system in which specific information of a tool is stored in a storage part of the tool, and the specific information is read out from the storage part of the tool by means of the terminal unit and displayed in a display part. Further, herein, the specific information of the tool is read out from the tool and stored in a database of an information processing unit.

### BACKGROUND ART

In structural, exterior, and interior works of home building, a pneumatic tool and a power tool which supply continuously a fastener such as a screw and a nail are being utilized widely. Though parts constituting these tools have the predetermined durability, with increase in the number of actual driving of the fastener and passage of current-carrying time of a motor, a tip portion of a driver becomes worn, or impact absorption effect of a bumper which absorbs impact of a driver piston lowers. Therefore, for example, when the number of actual driving of the tool comes to hundreds of thousands of times, maintenance work such as overhaul is performed, and broken parts are replaced. Further, oil filling is regularly performed thereby to prevent burning of an air motor.

In order to know the maintenance time of the tool, it is necessary to grasp the number of actual driving of the tool or the current-carrying time of the motor. As a tool capable of grasping the actual driving number, there has been proposed a tool including a nearby sensor which detects the reciprocation of a driver, and a counting circuit which counts the actual driving number of the tool based on detection signals detected by the nearby sensor. The actual driving number of the tool counted by the counting circuit is displayed in a liquid crystal display device (refer to Patent Document 1). A user, by reading out the actual driving number displayed in the liquid crystal display device, can determine whether the tool is into maintenance time or not.

### PRIOR ART DOCUMENT

### Patent Document

Patent Document 1: Japanese Patent Laid-Open No. H09-174460

However, the tool disclosed in the above Patent Document 1 has the following problem. Since the actual driving number of the tool is only displayed in the liquid-crystal display device, whether the tool is into the maintenance time or not must be determined by the user himself. Therefore, the user himself must grasp the actual driving number which requires maintenance, and he may erroneously determine the maintenance time. Further, the user may forget the maintenance time due to his forgetfulness. Passing of the tool maintenance time affects also other parts. Therefore, the broken portion increases, and the additional cost for replacement of parts is required.

Further, the tool disclosed in the above Patent Document 1 has also the following problems.

(1) According to the above tool, though the actual driving number of the tool can be acquired, specific information of the tool such as a manufacture serial number cannot be obtained. Generally, a tool manufacture serial number is shown by putting a sticker on which the manufacture serial number has been given on a surface of the tool, or by directly marking the manufacture serial number on the tool surface. However, in the course of using the tool, the sticker may tear off or the mark may disappear. In such the case, in the above tool, the manufacture serial number cannot be obtained, so that it is difficult to manage the tool in association with purchase information stored in a customer database.

(2) In case that the above tool is repaired, since repair information of the parts replaced in repair remains in only a repair center, a sales person, in order to acquire the repair information of the tool, must inquire of the repair center the repair information, so that there is a problem that it takes some time to acquire the repair information. This affects also sales promotion.

### SUMMARY OF INVENTION

The invention provides a tool which notifies exactly and surely a user about maintenance time, and an information processing unit which acquires readily maintenance information from the tool.

Further, the invention provides a tool, a terminal unit, and a management system which can acquire and manage specific information of the tool readily.

A tool according to the invention is characterized by including a detection means which detects maintenance information used in determination of maintenance time of a tool body, a control means which determines, based on a comparison result between the maintenance information detected by the detection means and basic maintenance information set in advance, whether the tool body is into the maintenance time or not, and a notice means which notifies the user that the tool body is into the maintenance time in case that the control means has determined that the tool body is into the maintenance time.

In the tool of the invention, the detection means detects the maintenance information of the tool body. The maintenance information includes, in case that the tool body is a pneumatic tool, for example, the number of actual driving; and in case that the tool body is a power tool, for example, the number of actual driving, current-carrying time of a motor, and the number of battery replacement. The detected maintenance information is supplied to the control means.

The control means compares the maintenance information with the basic maintenance information (threshold) stored in a storage part in advance. The basic maintenance information includes, for example, the actual driving number which becomes the criterion when warning of the part-replacement time based on durability of the tool is given, and the oil-filling number which requires oil filling. The control means determines based on the comparison result whether the tool body is into the maintenance time or not. For example, in case that the maintenance information is at least the basic maintenance information or over the basic maintenance information, the control means determines that the maintenance is required. The information based on this determination result is supplied to the notice means.

The notice means, based on the determination result by the control means, notifies the user that the tool body is into the maintenance time. For example, in case that the notice means is constituted by a light emitting part, this light emitting part is subjected to blinking light-emission thereby to notify the user about its fact. Further, in case that the notice means is constituted by a speaker, the user is notified about the fact by voice or buzzer sound. Hereby, the user can grasp the part-replacement time of the tool or the oil filling time thereof by the notice of the notice means before each part of the tool enters the endurance time.

Here, the maintenance in the invention includes the entire work of maintenance, check, management, and repair of a tool, such as overhaul performed when the tool reaches the specified actual driving number or the specified current-carrying time, or an oil-filling work of an air motor.

An information processing unit according to the invention including a detection means which detects maintenance information used in determination of maintenance time of a tool body, a tool control means which determines, based on a comparison result between the maintenance information detected by the detection means and basic maintenance information set in advance, whether the tool body is into the maintenance time or not, and a notice means of notifying, in case that the tool control means has determined that the tool body is into the maintenance time, a user that the tool body is into the maintenance time, in which the notice means acquires the maintenance information from a tool constituted by a light emitting means which emits the maintenance information as a light emission signal, is characterized by including a light receiving means which receives the light emission signal emitted from the light emitting means, an information processing control means which decodes the light emission signal received by the light receiving signal and generates an image signal based on the maintenance information, and a display means which displays on a screen the maintenance information based on the image signal generated by the information processing control means.

A tool according to the invention, in which specific information of a tool body is managed by an information processing unit, includes a communication part which performs communication with the information processing unit, a control part which obtains the specific information of the tool body inputted through the communication part from the information processing unit, and a storage part which stores the specific information of the tool body obtained by the control part; and is characterized in that the specific information is read out by the information processing unit through the communication part from the storage part of the tool body.

In the invention, the specific information of the tool inputted from the information processing unit is stored in the storage part of the tool. The specific information of the tool includes, for example, a customer number of a customer who owns the tool, a customer name, a purchase date of the tool, repair information of the tool, and usage information of the tool. The specific information stored in the storage part of the tool, for example, by causing a reading unit such as the information processing unit to read out the specific information from the storage part of the tool through the communication part of the tool, can be displayed on, for example, a screen of a display part.

A terminal unit according to the invention, which is a terminal unit for managing specific information of a tool, is characterized by including a first communication part for performing communication with the tool, a control part which reads out the specific information through the first communication part from a storage part of the tool, and a display part which displays the specific information read out by the control part.

In the invention, the specific information of the tool is read out through the first communication part of the terminal unit from the storage part of the tool, and displaced in the display part. Therefore, in standard of a data transmission path of an information processing unit such as a general personal computer, it was difficult to connect the information processing unit to a tool (control substrate of a tool). However, according to the terminal unit of the invention, it is possible to connect the terminal unit directly to the tool. Further, by providing a second communication part, it is possible to connect the information processing unit through the terminal unit to the tool. Namely, the terminal unit can function also as a relay device.

A management system according to the invention, in which specific information of a tool is managed by an information processing unit, is characterized in that: a tool includes a communication part which performs communication with an information processing unit and another information processing unit, a control part which obtains the specific information of the tool inputted through the communication part from the information processing unit and/or another information processing unit, and a storage part which stores the specific information of the tool obtained by the control part; and the information processing unit includes a communication part which performs communication with the tool, a control part which reads out the specific information of the tool through the communication part from the storage part of the tool, and a storage part having a database which stores the specific information of the tool read out by the control part.

In the invention, the specific information of the tool inputted from the information processing unit is stored in the storage part of the tool. The specific information of the tool includes, for example, a customer number of a customer who owns the tool, a customer name, a purchase date of the tool, repair information of the tool, and usage information of the tool. The specific information stored in the storage part of the tool can be displayed on, for example, a screen of a display part, for example, by causing a reading unit such as the information processing unit to read out the specific information from the storage part of the tool through the communication part.

In the database of the information processing unit, the specific information of the tool read out through the communication part from the storage part of the tool is stored. The specific information stored in the database can be displayed, for example, in a display part provided for the information processing unit. Hereby, an administrator can obtain the specific information of the tool from the database displayed on the screen of the display part.

Other features and advantage of the invention will be appear in description of embodiments and attached claims.

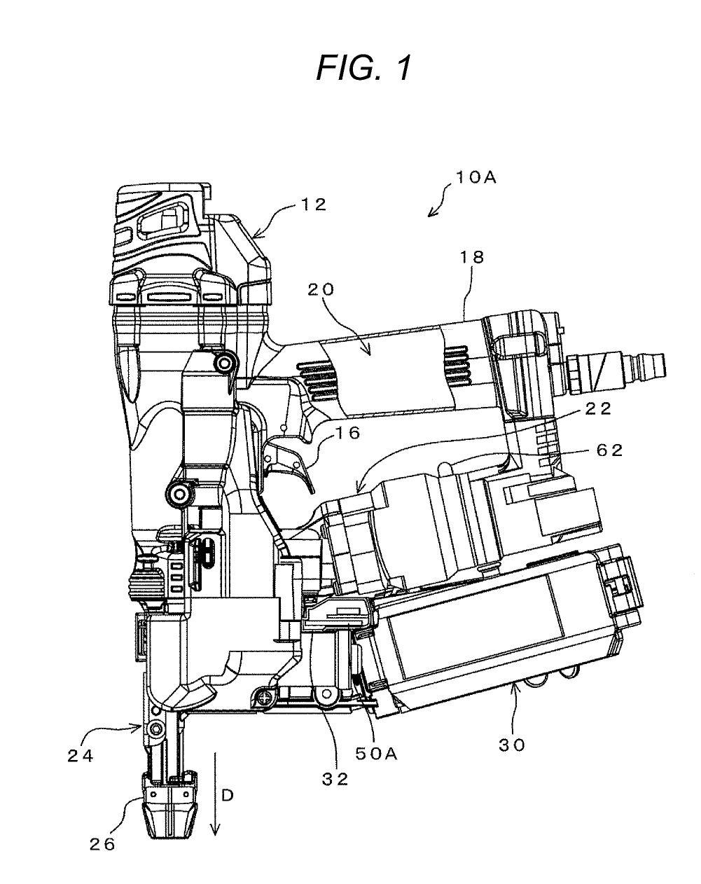

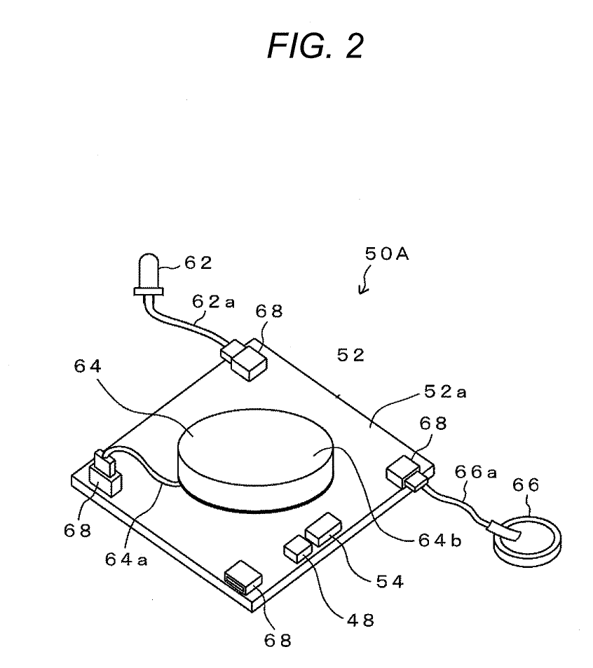

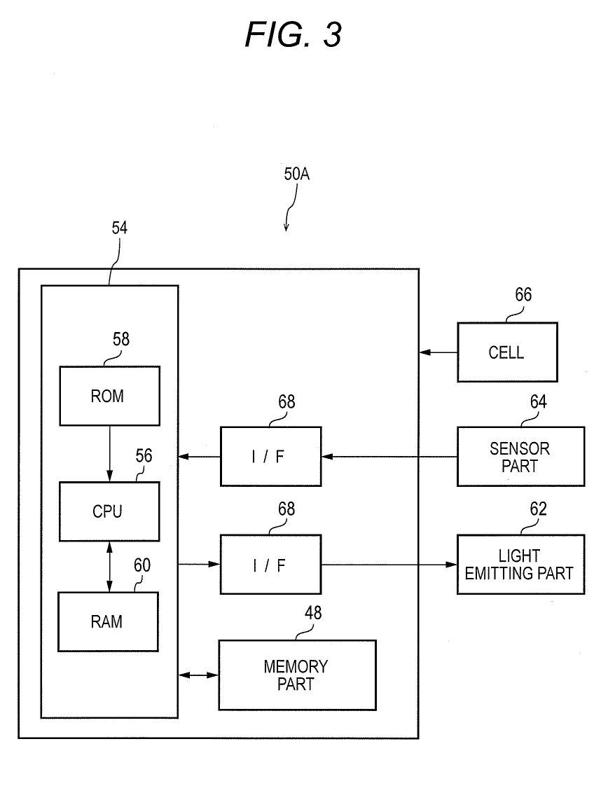

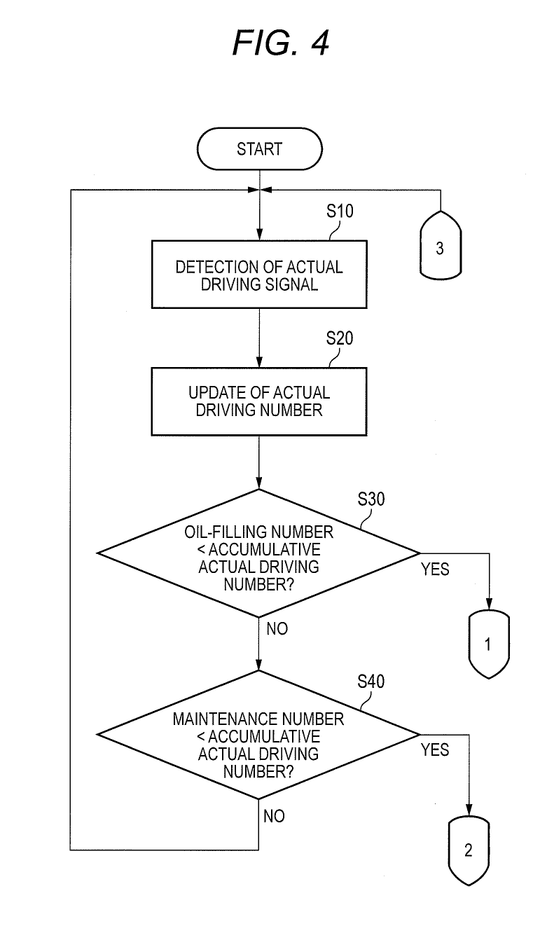

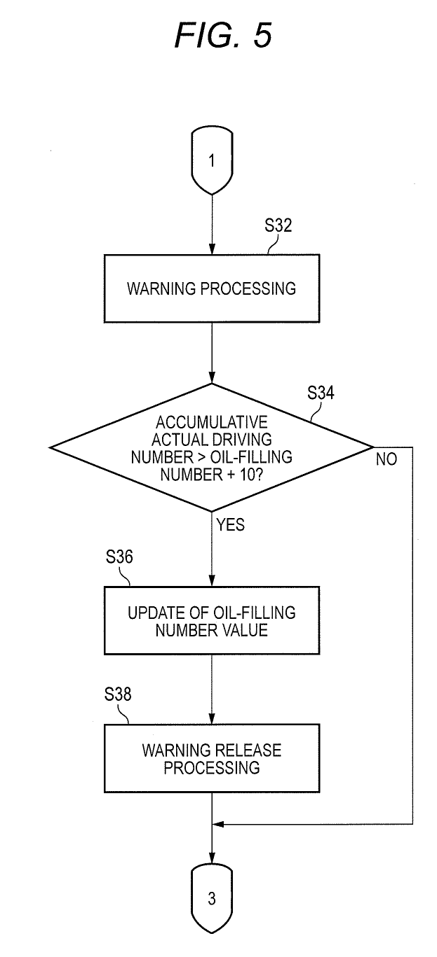

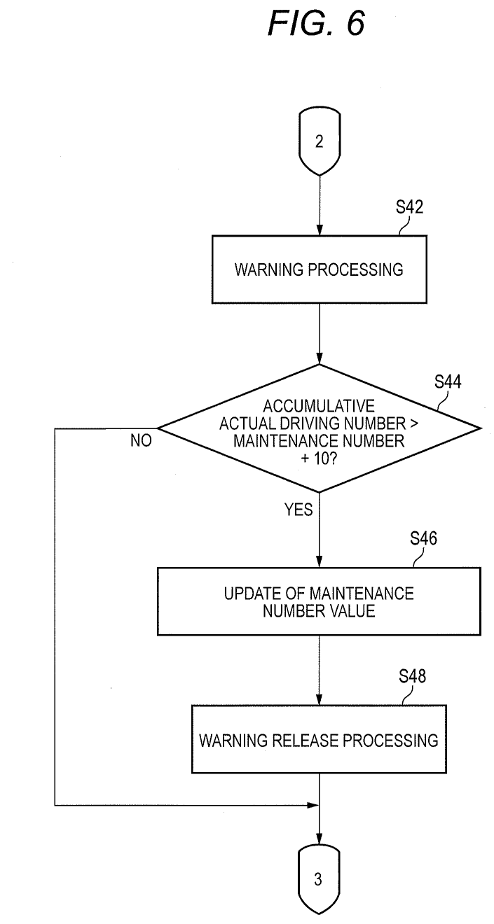

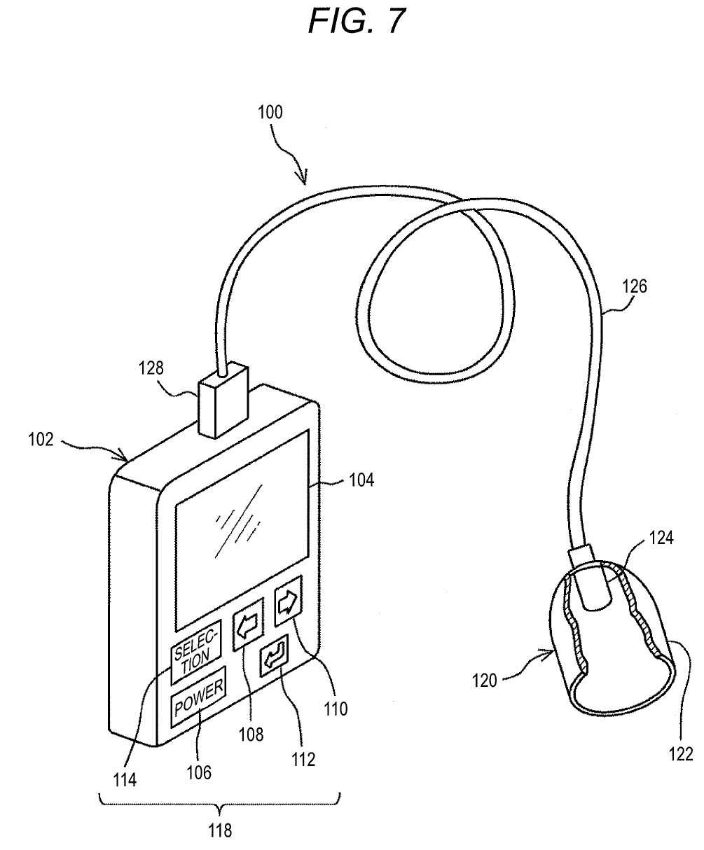

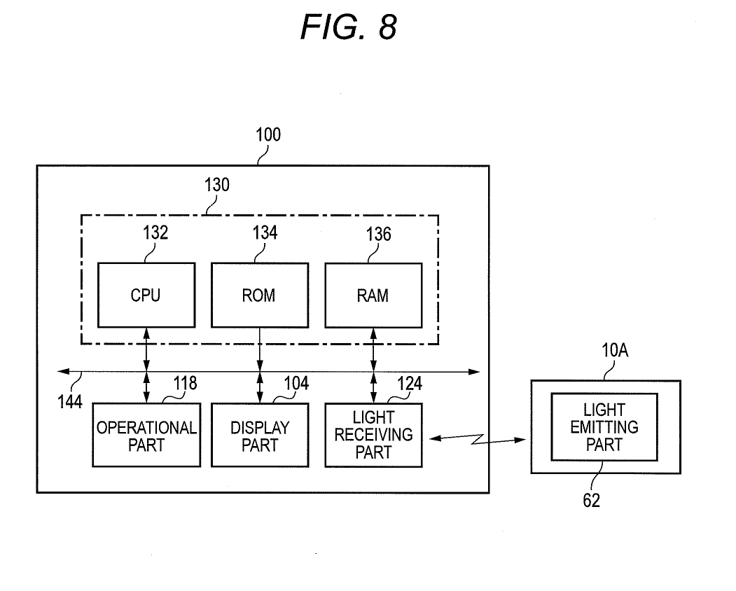

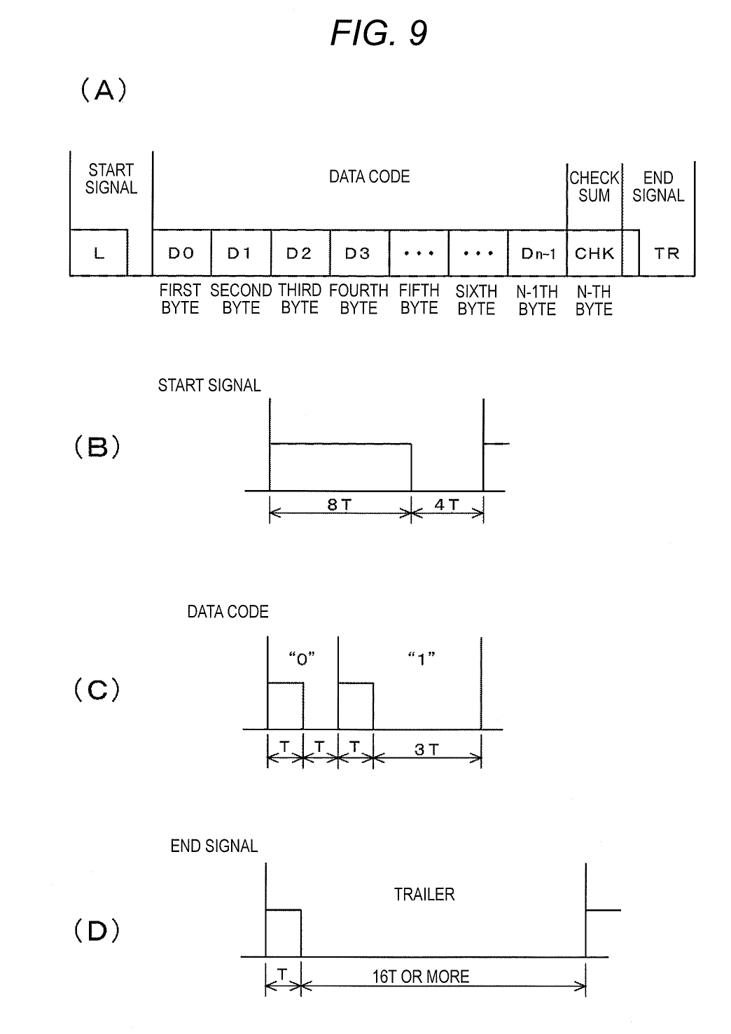

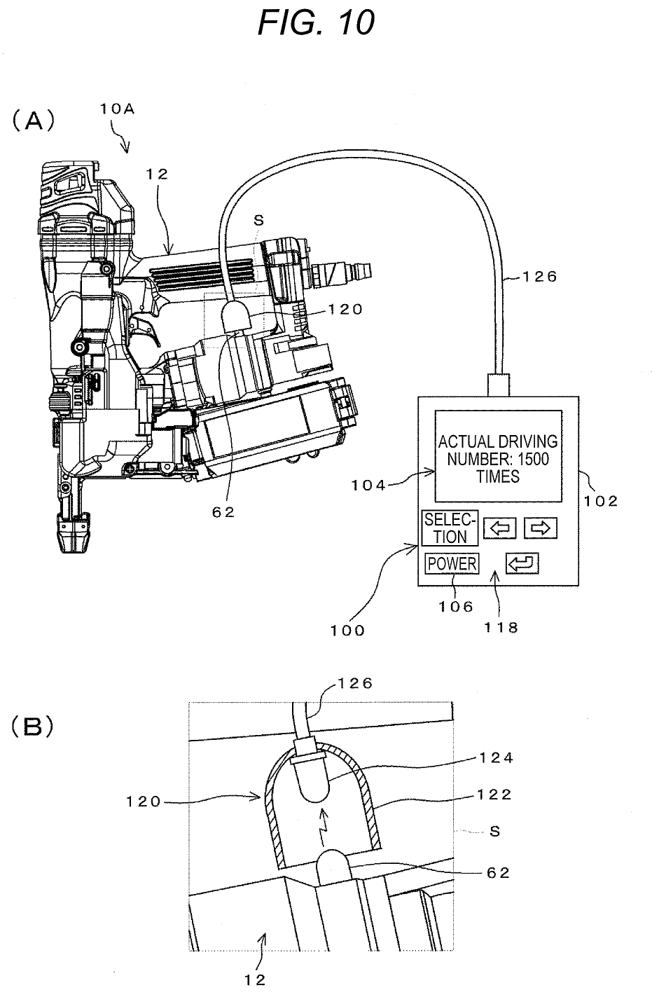

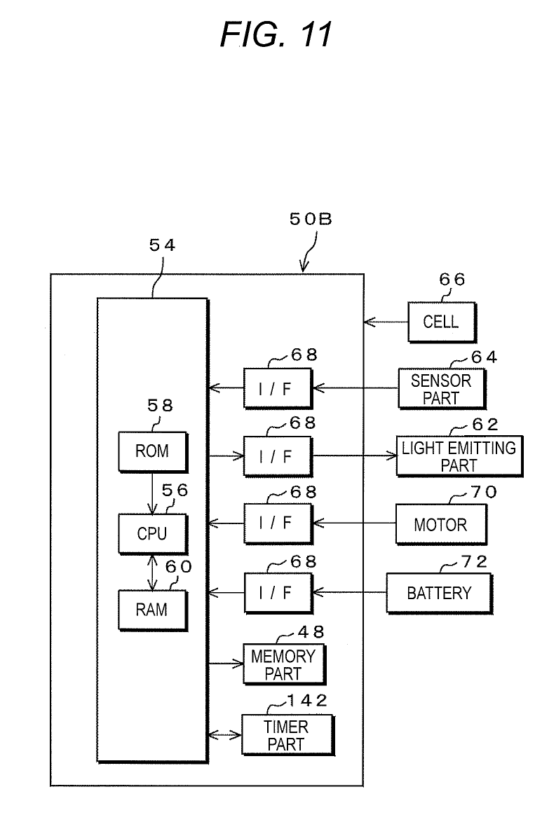

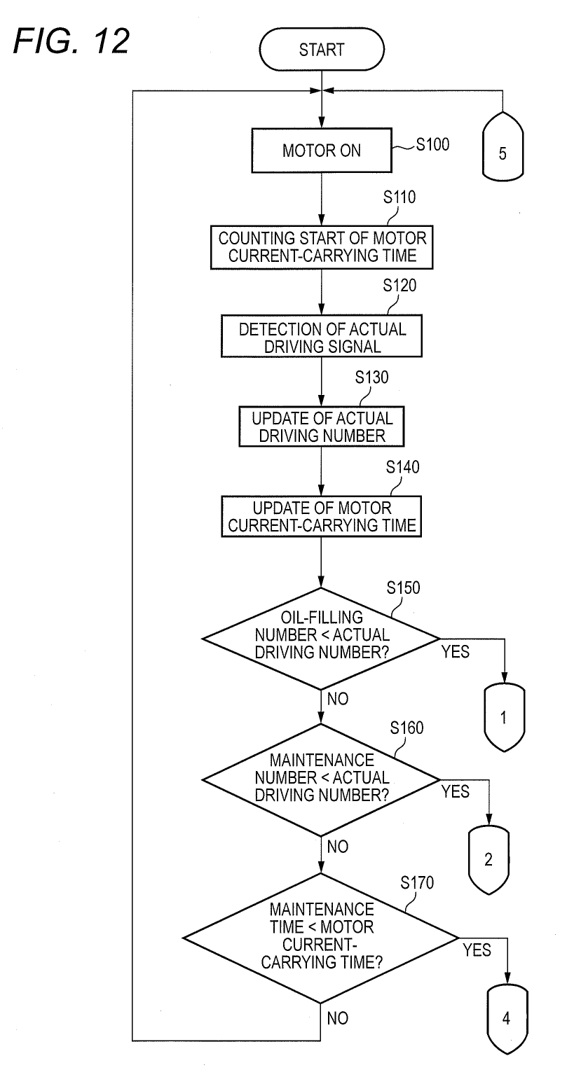

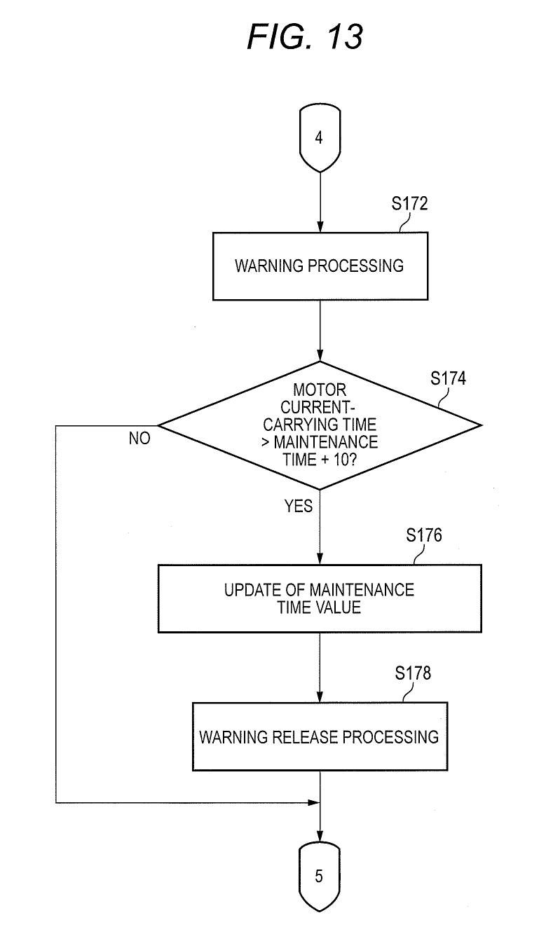

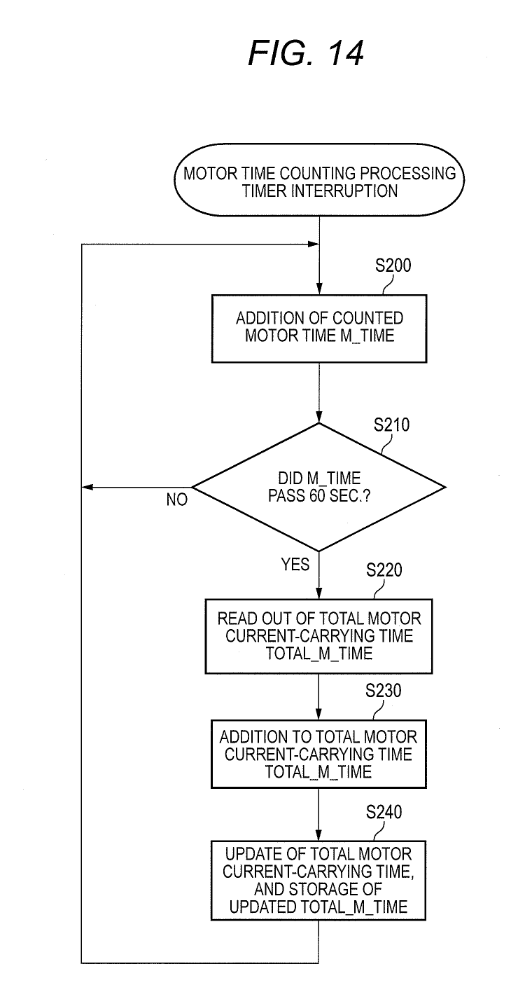

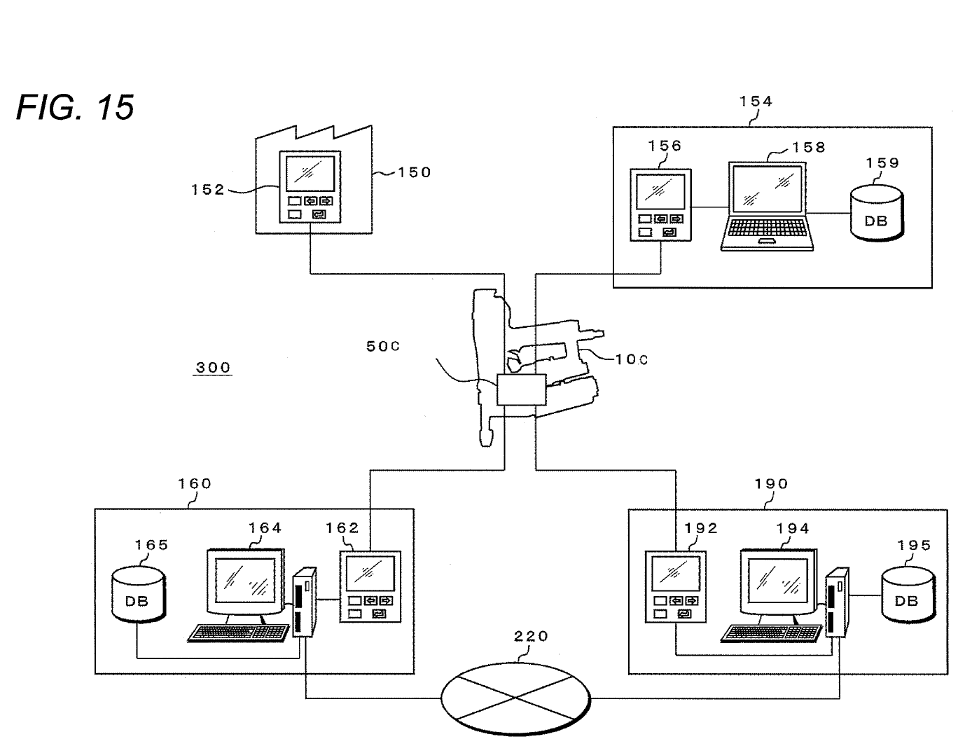

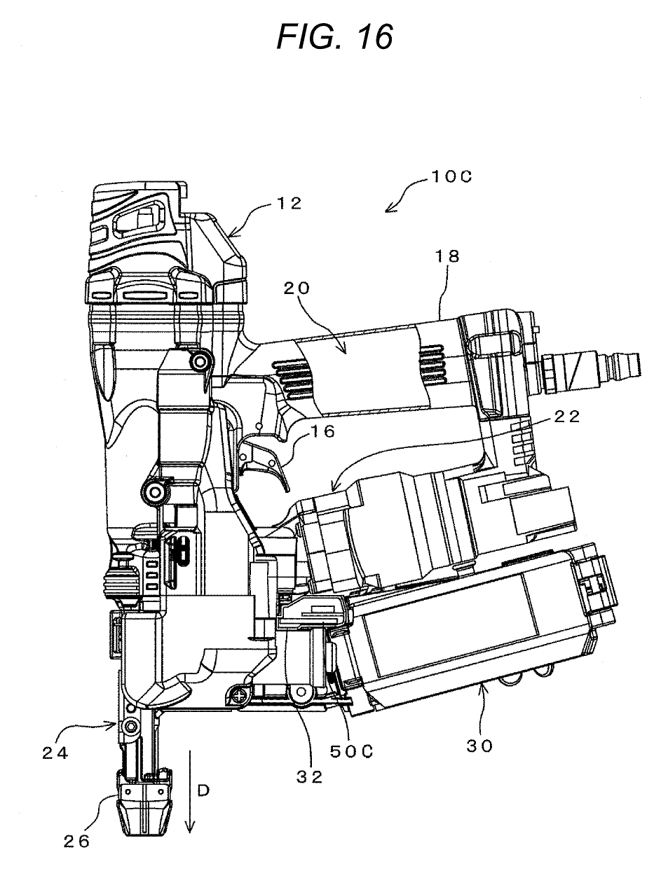

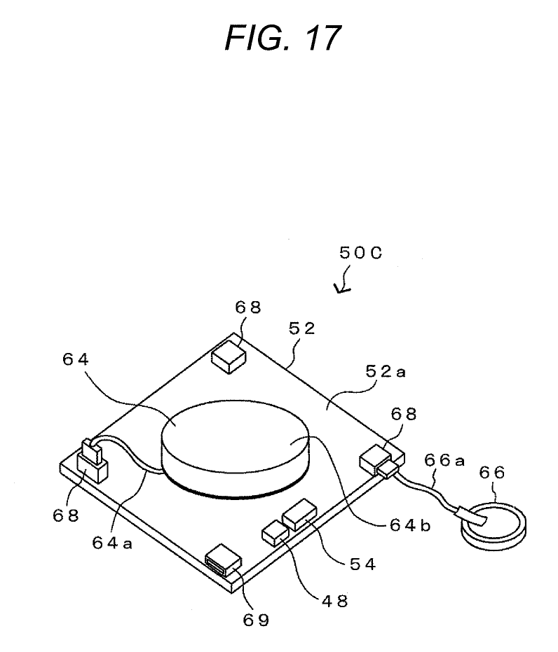

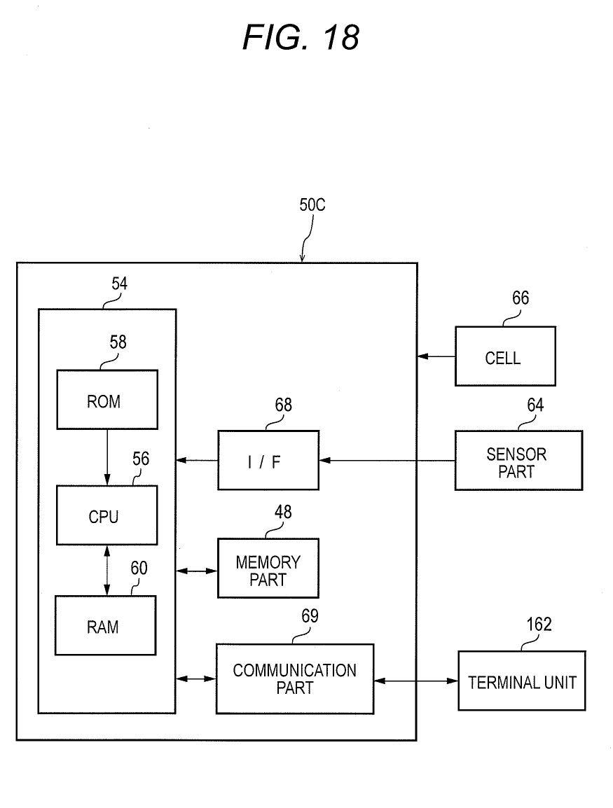

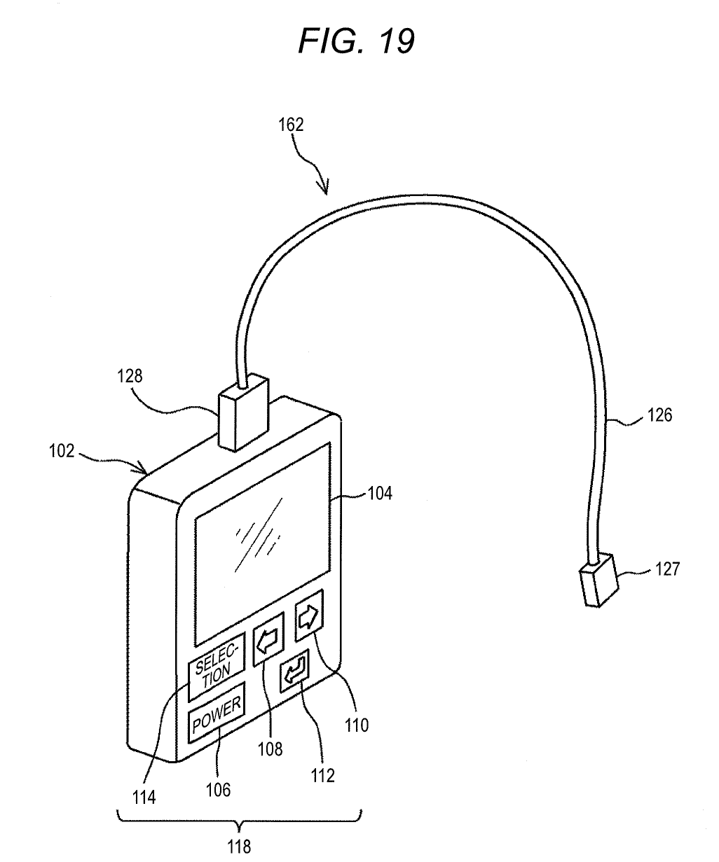

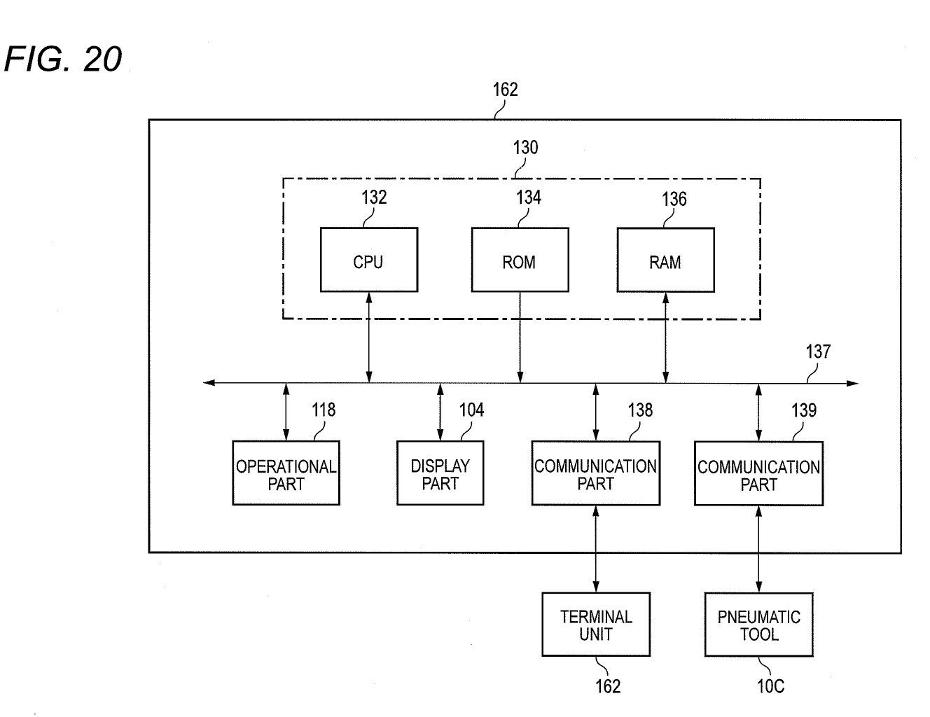

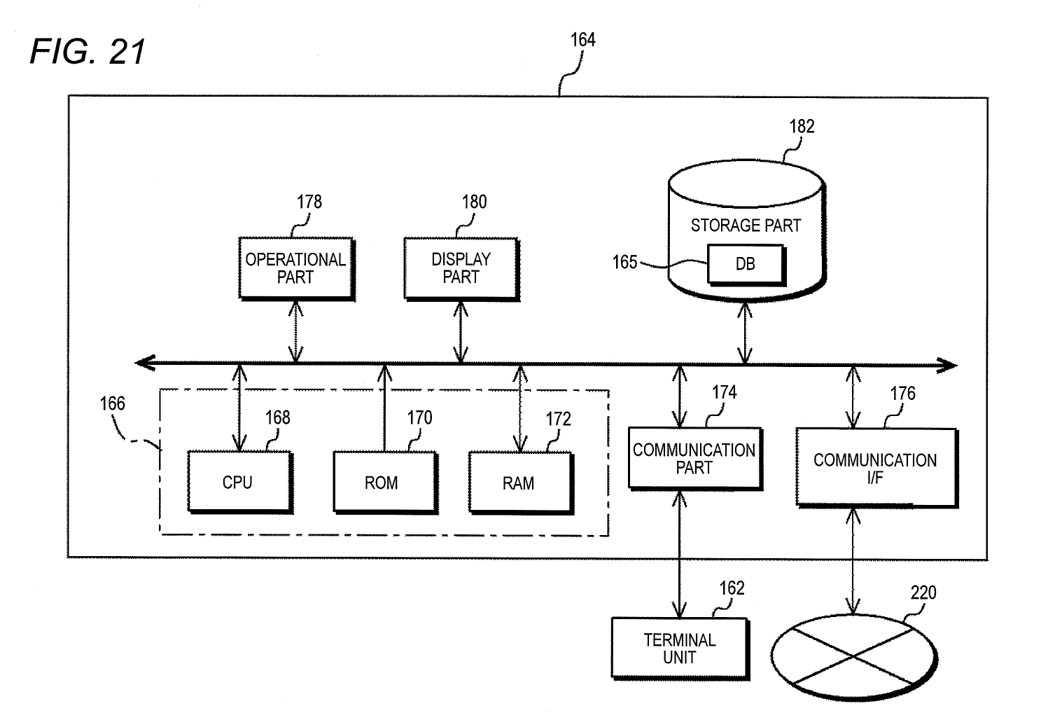

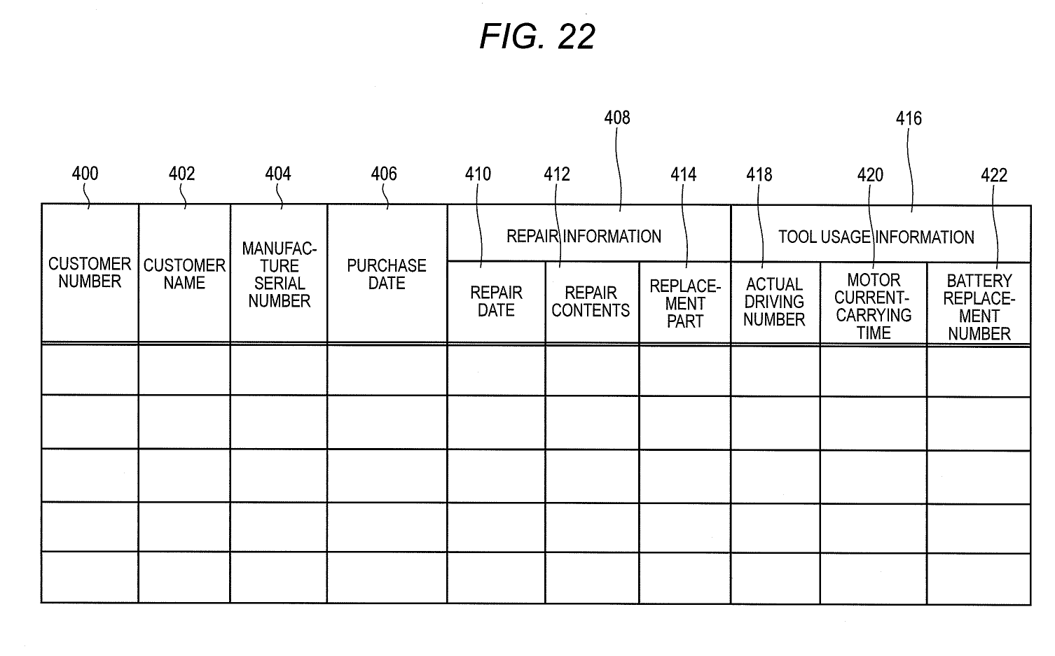

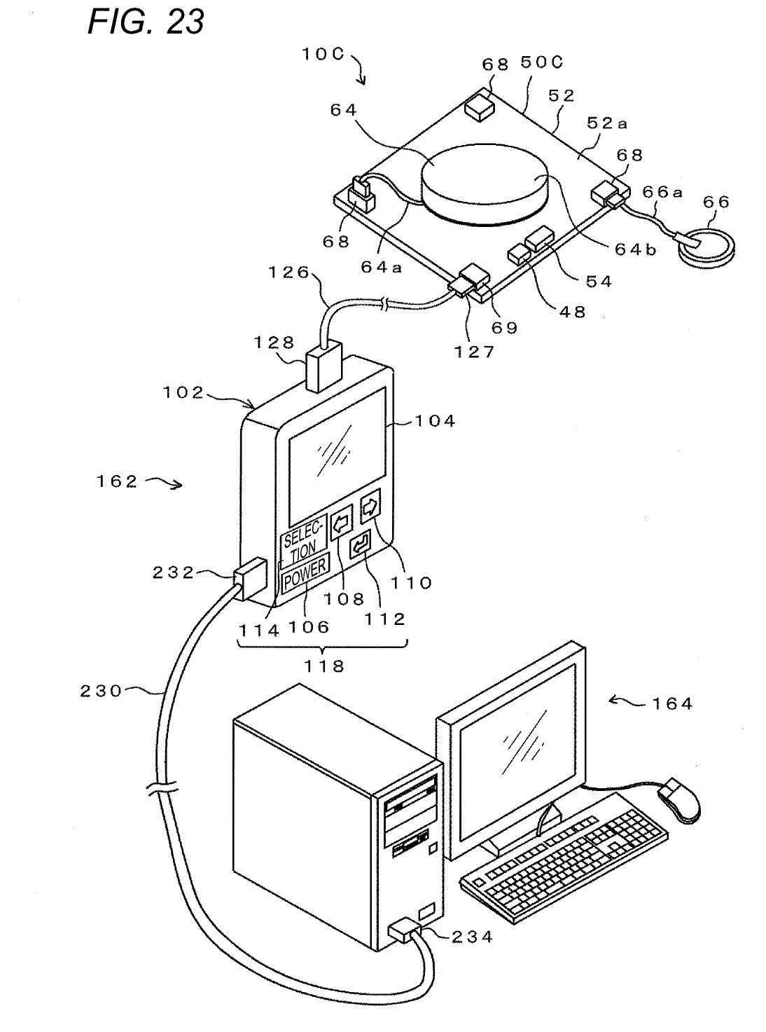

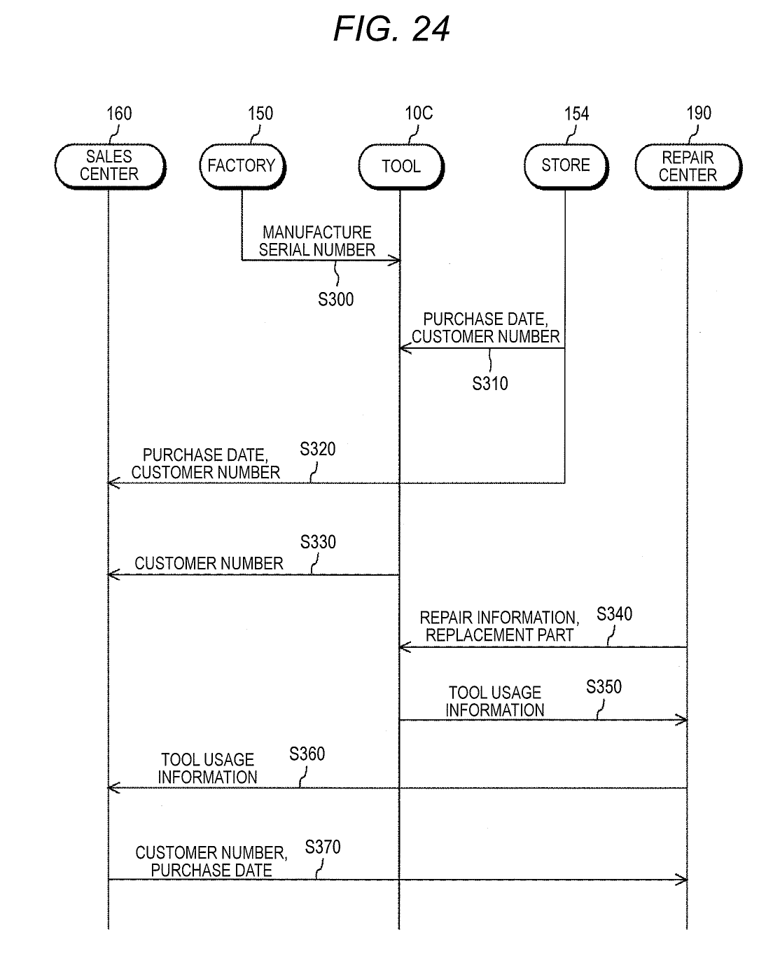

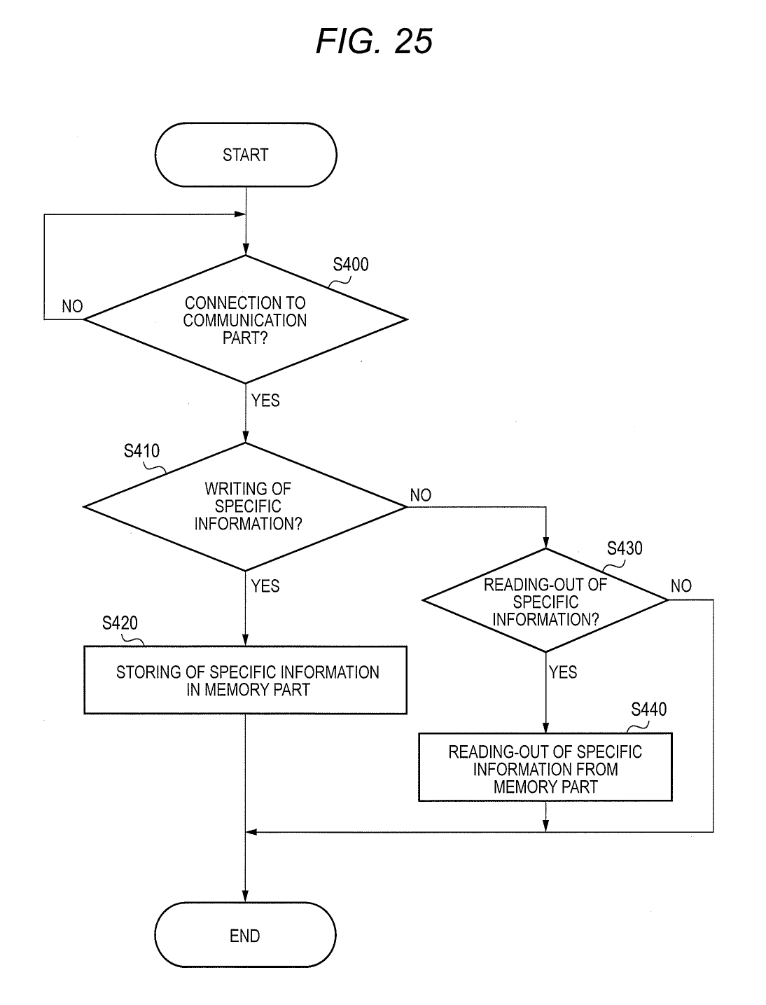

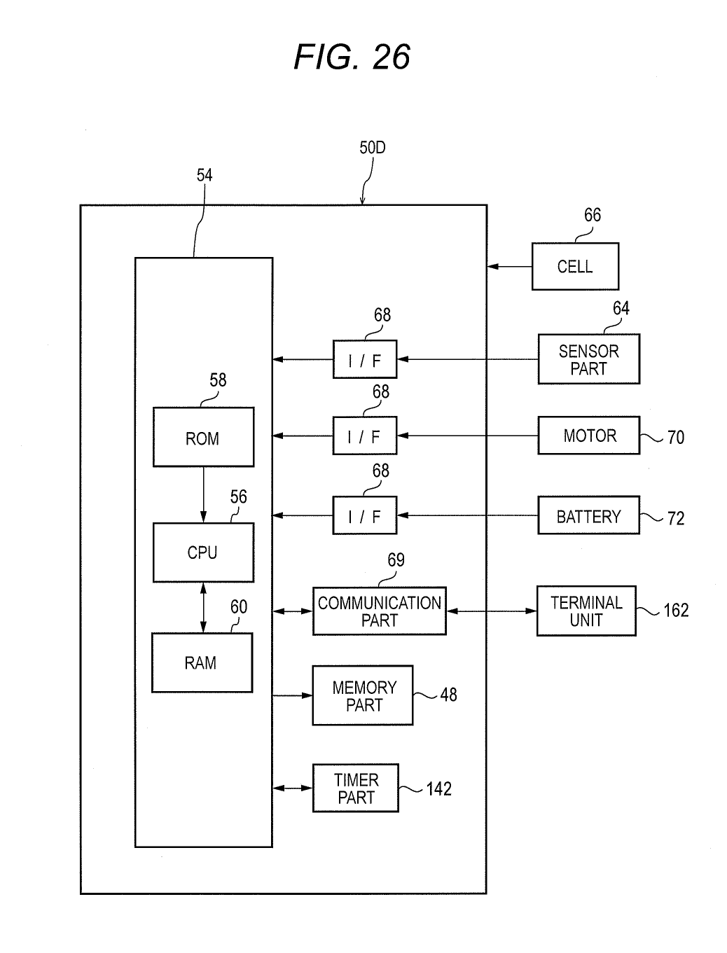

### BRIEF DESCRIPTION OF DRAWINGS

[FIG. 1] It is a diagram showing the configuration of a pneumatic tool according to a first embodiment of the invention.

[FIG. 2] It is a perspective view showing the configuration of a control substrate.

[FIG. 3] It is a diagram showing the block configuration of the pneumatic tool.

[FIG. 4] It is a first flowchart showing an example of the operation of the pneumatic tool.

[FIG. 5] It is a second flowchart showing an example of the operation of the pneumatic tool.

[FIG. 6] It is a third flowchart showing an example of the operation of the pneumatic tool.

[FIG. 7] It is a diagram showing the configuration of an information processing unit according to a second embodiment of the invention.

[FIG. 8] It is a diagram showing the block configuration of the information processing unit.

[FIG. 9] FIGS. 9(A) to 9(D) are diagrams showing the configuration of blinking signals emitted from a light emitting part.

[FIG. 10] FIGS. 10(A) and 10(B) are diagrams showing a using example of the information processing unit.

[FIG. 11] It is a diagram showing the configuration of a pneumatic tool according to a third embodiment of the invention.

[FIG. 12] It is a first flowchart showing an example of the operation of a power tool.

[FIG. 13] It is a second flowchart showing an example of the operation of the power tool.

[FIG. 14] It is a flowchart showing an example of the operation of time measuring processing of a motor.

[FIG. 15] It is a diagram showing a configuration example of a management system according to a fourth embodiment of the invention.

[FIG. 16] It is a diagram showing a configuration example of a pneumatic tool according to a fourth embodiment.

[FIG. 17] It is a perspective view showing a configuration example of a control substrate according to the fourth embodiment.

[FIG. 18] It is a diagram showing a block configuration example of the pneumatic tool according to the fourth embodiment.

[FIG. 19] It is a diagram showing a configuration example of a terminal unit according to the fourth embodiment.

[FIG. 20] It is a diagram showing a block configuration example of the terminal unit according to the fourth embodiment.

[FIG. 21] It is a diagram showing a block configuration example of an information processing unit according to the fourth embodiment.

[FIG. 22] It is a diagram showing a configuration example of a database according to the fourth embodiment.

[FIG. 23] It is a diagram showing a configuration example of connection among the control substrate, the terminal unit and the information processing unit according to the fourth embodiment.

[FIG. 24] It is a flowchart showing an operational example of the management system according to the fourth embodiment.

[FIG. 25] It is a flowchart showing an operational example of a control part in the pneumatic tool according to the fourth embodiment.

[FIG. 26] It is a diagram showing a block configuration example of a power tool according to a fifth embodiment.

### MODE FOR CARRYING OUT INVENTION

Embodiments of the invention will be described below with reference to FIGS. 1 to 26

### Embodiment 1

<Configuration of Pneumatic Tool>

FIG. 1 is a diagram showing a configuration example of a pneumatic tool 10A according to a first embodiment of the invention. The pneumatic tool 10A includes a tool body 12 and a control substrate 50A. The tool body 12 includes a not-shown driving mechanism, a nose part 24, a contact part 26, and a not-shown screw-fastening mechanism. The driving mechanism includes a driving cylinder, a driving piston provided slidably in the driving cylinder, and a driver bit coupled integrally to the driving piston. As shown in FIG. 1, when a trigger 16 is operated, compressed air is supplied into the driving cylinder from an air chamber 20 which stores the compressed air therein, and the driver bit performs a driving operation. The air chamber 20 is formed inside a grip part 18.

The nose part 24 has an ejection port for ejecting a screw (fastener) to a member to be screwed. A contact part 26 functions a safety unit. The contact part 26 is arranged slidably at the nose part 24, and urged so as to protrude to the screw driving side. The contact part 26 is so constituted that the configuration of the trigger 16 becomes effective only when the contact part 26 is pressed against the member to be screwed.

The screw-fastening mechanism causes the driver bit to perform the fastening operation by means of power of an air motor. Namely, almost simultaneously with the operation start of the driving mechanism, a part of the compressed air which has flown from the air chamber 20 shown in FIG. 1 is supplied to an air motor 22 thereby to rotate the driver bit around its axis. Then, by the rotating driver bit, a screw positioned in the ejection port is fastened into a not-shown member to be screwed (for example, plasterboard).

The tool body 12 includes a housing box 32. The housing box 32 accommodates therein a control substrate 50A which controls the maintenance time (part-replacing time) of the tool body 12. The housing box 32 is provided at a space portion between a front upper portion of a magazine 30 and a front lower portion of the air motor 22.

FIG. 2 shows a configuration example of the control substrate 50A. The control substrate 50A, as shown in FIG. 2, includes a substrate body 52, a memory part 48, a control part (tool control means) 54, plural interfaces (outlet, hereinafter described as I/F) 68, a cell 66, a sensor part 64, and a light emitting part 62. An information processing unit 100 which is connected to the I/F 68 of the control substrate 50A will be described later.

The substrate body 52 is a substrate made of a polyimide material, on which a not-shown wiring pattern has been formed. The substrate body 52 is arranged inside the housing box 32 (refer to FIG. 1) of the tool body 12. The I/F's 68 are provided at respective corner portions of a main surface 52a of the substrate body 52. The control part 54 is constituted by a microcomputer, which counts the number of actual driving of the tool body 12 and determines the maintenance time of the tool body 12.

The memory part 48 is an example of a storage means, which is composed of a nonvolatile semiconductor memory (for example, flash memory). In the memory part 48, maintenance information of the tool body 12 is stored. The maintenance information includes data such as the accumulative actual-driving number of the pneumatic tool 10A, the basic actual driving number which becomes the criterion when warning of the maintenance time is given, the basic oil-filling number which becomes the criterion when warning of the oil-filling time is given, a manufacture serial number of the pneumatic tool 10A, and a manufacturing date and time. The memory part 48 may be integrally built in the control part 54.

The cell 66 has the shape of a button and is arranged inside the tool body 12 (refer to FIG. 1). To the cell 66, one end of a lead wire 66a is connected, and the other end of the lead wire 66a is connected through the I/F 68 to the substrate body 52. The cell 66, only when actual driving of the tool body 12 has been detected by the sensor part 64, supplies electric power to the control part 54. Hereby, consumption of the cell 66 is reduced, and the replacing number of the cell 66 can be reduced. By using the cell 66, weight-reduction of the pneumatic tool 10A can be realized.

The sensor part 64 is an example of a detection means, which is composed of, for example, an impact sensor or an acceleration sensor. To the sensor part 64, one end of a lead wire 64a is connected, and the other end of the lead wire 64a is connected through the I/F 68 to the substrate body 52. The sensor part 64 is accommodated in the housing box 32 so that its flat portion 64b becomes vertical to a driving direction D (refer to FIG. 1) of the tool body 12. Hereby, the sensor part 64 can detect accurately the actual driving of the tool body 12. Instead of using the above-mentioned sensor part 64, attaching a sensor (switch) to the trigger 16, the contact part 26 shown in FIG. 1, or a not-shown feed part may be adopted to detect the actual driving number of the tool body 12.

The light emitting part 62, which is an example of a notice means and a light emitting means, is composed of, for example, LED. The light emitting part 62 is attached in the lower position of the grip part 18 of the tool body 12 (on the upper surface portion of the air motor 22) (refer to FIG. 1). To the light emitting part 62, one end of a lead wire 62a is connected, and the other end of the lead wire 62a is connected through the I/F 68 to the substrate body 52. Hereby, even in case that the pneumatic tool 10A is used slantingly in any direction of a ceiling surface, a floor surface, and a mirror surface, the user can recognize visually light emission of the light emitting part 62 with ease. The light emitting part 62 can be attached also to another position than the above-mentioned position as long as the user can recognize visually the light emission in that position.

Next, the block configuration of the pneumatic tool 10A including the control substrate 50A will be described. FIG. 3 shows the block diagram of the pneumatic tool 10A. The sensor part 64 of the pneumatic tool 10A, as shown in FIG. 3, detects the impact or the acceleration when the tool body 12 has performed the actual driving to generate detection signals, and supplies the generated detection signals to the control part 54 and the cell 66 respectively. The cell 66 generates the electric power based on the supplied detection signals and supplies the electric power to the control part 54.

The control part 54 is composed of a Central Processing Unit (CPU) 56, a Read Only Memory (ROM) 58 and a Random Access Memory (RAM) 60. The ROM stores various programs for determining the maintenance time of the tool body 12, and data necessary for processing. The RAM 60 is used mainly as an operation area of various processing. For example, the RAM 60 stores and holds temporarily the data obtained when the CPU 56 performs various processing. The CPU 56 executes the programs stored in the ROM 58 and performs control such as maintenance warning of the tool body 12 and management.

The control part 54, after being actuated by the electric power supplied from the cell 66, determines whether the detection signal supplied from the sensor part 64 indicates actual driving or non-actual driving. As a determining method, for example, a threshold (voltage value) is stored previously in the ROM 58; and in case that the detection signal is equal to or larger than the threshold upon comparison between this threshold and a value (voltage value) of the detection signal, it is determined that the detection signal indicates the actual driving. The determination may be performed based on length of continuous time of the detection signal. The control part 54 counts the detection signals judged to be actual driving; and in case that the counted accumulative actual-driving number exceeds the predetermined basic maintenance number, the control part 54 generates a control signal for causing the light emitting part 62 to emit the light and supplies the control signal to the light emitting part 62.

The light emitting part 62, based on the control signal supplied from the control part 54, emits the light at the predetermined pattern, and warns the user that the tool body 12 is into the maintenance time. At this time, for example, in case that the light emitting part 62 warns the user of the oil-filling time, a blinking pattern may be made quick; and in case that the light emitting part 62 warns the user of the maintenance time such as overhaul, a blinking pattern may be made slower than the blinking pattern of the oil-filling time. Hereby, the user can recognize readily what the warning indicates. The warning means, in place of the light emitting part 62, may be a speaker which outputs a voice or a buzzer sound.

In case that the maintenance information such as the actual driving number stored in the memory part 48 of the control substrate 50A is read out by an information processing unit 100 described later, the control part 54 reads out the maintenance information stored in the memory part 48, generates a transmission signal based on the read-out maintenance information, and supplies the transmission signal to the light emitting part 62.

The light emitting part 62 converts the transmission signal supplied from the control part 54 into a blinking signal (light emission signal) using infrared rays and transmits (emits) the converted blinking signal. As the blinking signal, for example, a signal modulated by carrier frequency is used.

<Operation of Pneumatic Tool>

Next, an example of the operation of the control part 54 in case that warning of the maintenance time of the pneumatic tool 10A is given will be described. FIG. 4 is a flowchart showing the operation of the control part 54 in case that warning of the maintenance time of the pneumatic tool 10A is given.

In a step S10, the control part 54 detects a detection signal supplied from the sensor part 64. The control part 54 determines from a waveform of the detection signal supplied from the sensor part 64 whether the detection signal indicates actual driving or non-actual driving (idle driving). In the embodiment, the detection signal supplied from the sensor part 64 is taken as the actual driving. After detection of the detection signal, the control part 54 proceeds to a step S20.

In the step S20, the control part 54 updates the actual driving number stored previously in the memory part 48. The control part 54, when the detection signal has been supplied from the sensor part 64, reads out the actual driving number from the memory part 48, and adds +1 (increment) to the read-out actual driving number to update the actual driving number. The updated actual driving number is stored again in the memory part 48 as the accumulative actual driving number. The control part 54, after updating the actual driving number, proceeds to a step S30.

In the step S30, the control part 54 compares the accumulative actual driving number with the previously set oil-filling number (basic maintenance information), and determines whether the accumulative actual driving number exceeds the oil-filling number or not. The control part 54 reads out the updated accumulative actual driving number and the previously stored oil-filling number (threshold) from the memory part 48, and compares the accumulative actual driving number with the oil-filling number. In case that the oil-filling number is set, for example, to 2000 fasteners, the control part 54 determines whether the updated accumulative actual driving number exceeds 2000 fasteners or not. The control part 54, in case that it has determined that the updated accumulative actual driving number exceeds 2000 fasteners, proceeds to a step S32 shown in FIG. 5, and in case that it has determined that the updated accumulative actual driving number is below the oil-filling number, proceeds to a step S40.

FIG. 5 is a flowchart showing the operation of the control part 54 in case that warning of the oil-filling time is given. In the step S32, the control part 54 performs warning processing of warning the user that the oil filling operation is required. In the warning processing, the control part 54 supplies a control signal for light emission and blink to the light emitting part 62 and blinks the light emitting part 62 at the predetermined pattern. The time for which the light emitting part 62 is blinked can arbitrarily set.

In a step S34, the control part 54 compares “the accumulative actual driving number” with “the number of oil filling+ten times”, and determines whether “the accumulative actual driving number” exceeds “the number of oil filling+10 times” or not. Hereby, for only the time of “+10 times” since the accumulative actual driving number came to “the number of oil filling”, the light emitting part 62 blinks. Therefore, the user can notice surely the warning by the light emitting part 62 for this time. For example, in case that the number of oil filling is set to 2000 times, for the time till the accumulative actual driving number comes to 2010 times from 2000 times, the light emitting part 62 blinks. The accumulative actual driving number to be added is not limited to “+10 times”. For example, in case that the number of times larger than “+10 times” is added, for a long time since the accumulative actual driving number came to the specified oil-filling number, it is possible to alarm the user that the oil-filling operation is necessary. In case that it has determined that “the accumulative actual driving number” exceeds “the number of oil filling+10 times”, the control part 54 proceeds to a step S36. On the other hand, the control part 54, in case that it has determined that “the accumulative actual driving number” is below “the number of oil filling+10 times”, returns to the step S10 and detects again a detection signal.

In the step S36, the control part 54 updates a numerical value of the oil-filling number. The control part 54 reads out the oil-filling number from the memory part 48, and in case that the oil-filling number is set to, for example, 2000 times, the control part 54 sets newly the oil-filling number to 4000 times which is double, and stores the updated oil-filling number in the memory part 48. Hereby, when the accumulative actual driving number comes to 4000 times, the light emitting part 62 blinks again. The oil-filling number to be set newly may be set in consideration of aged deterioration so that the oil-filling number interval becomes short with increase of the accumulative actual driving number. The control part 54, after updating the numerical value of the oil-filling number, proceeds to a step S38.

In the step S38, the control part 54 performs warning release processing. In the warning release processing, the control part 54, after blinking the light emitting part 62 for only the predetermined time, stops the blinking light emission of the light emitting part 62. After the light emission has stopped, the control part 54 returns to the step S10.

Turning to FIG. 4, in a step S40, the control part 54 compares the accumulative actual driving number with the previously set maintenance number (basic maintenance information), and determines whether the accumulative actual driving number exceeds the maintenance number or not. For example, in case the maintenance number is set to 200,000 times, the control part 54 determines whether the updated accumulative actual driving number exceeds 200,000 times or not. In case that the accumulative actual driving number has exceeded 200,000 times, the control part 54 proceeds to a step S42 shown in FIG. 6. On the other hand, in case that the accumulative actual driving number is below 200,000 times, the control part 54 returns to the step S10, and detects again a detection signal.

FIG. 6 is a flowchart showing the operation of the control part 54 in case that warning of the maintenance time is given. The operation common to that in FIG. 5 will be described with simplification. In the step S42, the control part 54 performs warning processing of warning the user that the overhaul operation is required. In the warning processing, the control part 54 supplies a control signal for light emission and blink to the light emitting part 62 and blinks the light emitting part 62 at the predetermined pattern.

In a step S44, the control part 54 compares “the accumulative actual driving number” with “the maintenance number+ten times”, and determines whether “the accumulative actual driving number” exceeds “the maintenance number+10 times” or not. Hereby, for only time of “+10 times” since the accumulative actual driving number came to “the maintenance number”, the light emitting part 62 blinks. Therefore, the user can notice surely the warning by the light emitting part 62 for this time. For example, in case that the maintenance number is set to 200,000 times, for time till the accumulative actual driving number comes to 200010 times from 200,000 times, the light emitting part 62 blinks. The control part 54, in case that it has determined that “the accumulative actual driving number” exceeded “the maintenance number+10 times”, proceeds to a step S46. On the other hand, the control part 54, in case that it has determined that “the accumulative actual driving number” is below “the maintenance number+10 times”, returns to the step S10 and detects again a detection signal.

In the step S46, the control part 54 updates a numerical value of the maintenance number. The control part 54 reads out the maintenance number from the memory part 48; and in case that the maintenance number is set to, for example, 200,000 times, the control part 54 sets newly the maintenance number to 400,000 times which is double, and stores the updated maintenance number in the memory part 48. Hereby, when the accumulative actual driving number comes to 400,000 times, the light emitting part 62 blinks again. The control part 54, after updating the numerical value of the maintenance number, proceeds to a step S48.

In the step S48, the control part 54 performs warning release processing. In the warning release processing, the control part 54, after blinking the light emitting part 62 for only the predetermined time, stops the blink of the light emitting part 62. Upon completion of the warning release processing, the control part 54 returns to the step S10 and detects a detection signal again. By such the operation of the control part 54, the light emitting part 62 is blinked to give the warning when the accumulative actual driving number has come to the specified oil-filling number or maintenance number. Therefore, the user can grasp accurately the maintenance time.

As described above, according to the embodiment, when the accumulative actual number of the pneumatic tool 10A has come to the previously set maintenance number or oil-filling time, the light emitting part 62 performs blinking light-emission, whereby it is warned that the pneumatic tool 10A is into the maintenance time. Therefore, the user can grasp surely and accurately the maintenance time of the tool. Hereby, passing of the maintenance time can be prevented, and expansion of the parts-broken portion can be prevented by repairing the parts in advance. In result, the additional cost of the repair can be reduced.

### Embodiment 2

Next, the configuration of an information processing unit 100 for reading out, from the control substrate 50A of the above-mentioned pneumatic tool 10A, the actual driving number of the pneumatic tool 10A will be described. The configuration of the pneumatic tool 10A which has been described in the above-mentioned first embodiment is omitted.

<Configuration of Information Processing Unit>

The configuration of the information processing unit 100 for reading out, from the control substrate 50A of the pneumatic tool 10A, the actual driving number of the pneumatic tool 10A will be described. FIG. 7 is a perspective view showing a configuration example of the information processing unit 100. The information processing unit 100 includes a unit body 102 and a receiver 120. The unit body 102 and the receiver 120 are electrically interconnected through a cable 126.

The unit body 102 has a housing formed in the shape of a flat rectangular parallelepiped. On a housing surface, a display part 104 and an operational part 118 are provided. The display part 104 is composed of, for example, a Liquid Crystal Display (LCD) or an Electro Luminescence (EL), and displays, on a screen, specific information of the pneumatic tool 10A read out from the control substrate 50A, such as the actual driving number of the pneumatic tool 10A, a manufacture serial number, and a purchase date and time.

The operational part 118 includes a power button 106 which switches on/off a power source of the unit body 102, a left-movement button 108 which moves a cursor in a left direction, a right-movement button 110 which moves a cursor in a right direction, a line-feed button 112 which moves a cursor on the screen to a new line, and a selection button 114 which selects a command. As an input unit, a touch panel in which a display part 104 and an operational part 118 are integrally combined may be used.

The receiver 120 has a light receiving part 124 and a cover member 122. The light receiving part 124 is composed of, for example, a photodiode. To a back end portion of the light receiving part 124, one end of the cable 126 is connected, and the other end of the cable 126 is detachably connected to the unit body 102 through a connector 128.

The cover member 122 is used for removing influences by ambient light, and formed of such material as to prevent a signal from the outside from entering the receiver 120. The cover member 122 is formed nearly in the shape of a bowl, and is attached to a base end portion of the light receiving part 124 so as to surround the peripheral portion of the light receiving part 124.

Next, the block configuration of the information processing unit 100 will be described. FIG. 8 shows the block configuration of the information processing unit 100. To a bus 144, the operational part 118, a not-shown signal processing part 140, a control part (information processing control means) 130 and the display part 104 are connected respectively.

The operational part 118 generates an operational signal based on user's button operation, and supplies the generated operational signal to the control part 130. In the operational part 118, for example, a command for displaying all the maintenance information stored in the pneumatic tool 10A, a command for displaying a part of the maintenance information, for example, only the actual driving number, and a command for switching on/off the power source of the information processing unit 100 are inputted by the user.

The light receiving part 124 receives a blinking signal (refer to FIG. 3) emitted from the light emitting part 62 on the pneumatic tool 10A side, and converts the received blinking signal into an electric signal. The light receiving part 124 subjects the electric signal converted from the blinking signal to amplification processing, and supplies the amplified signal to the control part 130.

The configuration of the blinking signal emitted from the light emitting part 62 will be described. FIG. 9(A) shows a configuration example of the blinking signal. FIG. 9(B) shows a configuration example of a start signal. FIG. 9(C) shows a configuration example of a data code. FIG. 9(D) shows a configuration example of an end signal.

The blinking signal, as shown in FIG. 9(A), includes a start signal, a data code, a checksum, and an end signal. The start signal is a marker indicating the start of the blinking signal. The start signal is greatly different from the data code in signal waveform, and constituted so as to be capable of being readily identified as a start signal. In the start signal, as shown in FIG. 9(B), the duty factor is set to 2:1. For example, the duty factor is set so that in a period of 8 ms, an ON-state continues, and thereafter in a period of 4 ms, an OFF-state continues.

The data code includes data such as the actual driving number of the pneumatic tool 10A, and is composed of data of the first byte to the n-1th byte. In the data code, as shown in FIG. 9(C), in case of a “0” bit, the duty factor of ON/OFF is set to 1:1; and in case of a “1” bit, the duty factor of ON/OFF is set to 1:3.

The checksum is algorithm used in error detection of the data code, and is composed of a lower byte of the sum of the first byte to the n-1th byte.

The end signal is a marker indicating the end of the blinking signal. The end signal is greatly different from the data code in signal waveform, and constituted so as to be capable of being readily identified as an end signal. In the end signal, as shown in FIG. 9(D), the duty factor is set to 1:16 or more. For example, the duty factor is set so that in a period of 1 ms, an ON-state continues, and thereafter in a period of 16 ms or more, an OFF-state continues.

Turning to FIG. 8, the control part 130 includes a CPU 132, a ROM 134, and a RAM 136. The control part 130 extracts a carrier frequency component of the blinking signal supplied from the light receiving part 124 to perform decoding processing, and generates an image signal based on the maintenance information. The control part 130 supplies the generated image signal to the display part 104.

The control part 130 generates a control signal based on the operation signal supplied from the operational part 118, and supplies the generated control signal to the display part 104 to perform various processing. For example, by controlling power ON/OFF of the information processing unit 100, the control part 130 controls display of the maintenance information to be displayed on the screen of the display part 104.

The display part 104 displays on the screen an image based on the image signal supplied from the CPU 132 of the control part 130. On the screen of the display part 104, the maintenance information of the pneumatic tool 10A such as the accumulative actual driving number and a manufacture serial number read out from the memory part 48 of the tool body 12 is displayed.

<Usage Example of Information Processing Unit>

Next, a usage example of the information processing unit 100 will be described. FIG. 10(A) shows a usage example of the information processing unit 100. FIG. 10(B) is an enlarged view of a main part S in FIG. 10(A).

As shown in FIGS. 10(A) and 10(B), in case that the accumulative actual driving number is read out from the pneumatic tool 10A, firstly, the power button 106 of the unit body 102 is pushed to switch on the power supply of the information processing unit 100 (refer to FIG. 8). Next, the cover member 122 of the receiver 120 is pressed against (or brought close to) the tool body 12 so as to surround the light emitting part 62 of the tool body 12. After the cover member 122 of the receiver 120 has been pressed against the tool body 12, a not-shown switch provided on the tool body 12 side is pushed on to blink the light emitting part 62 of the tool body 12. Alternatively, the light emitting part 62 is blinked by an operation which cannot occur in the usual actual driving. For example, a fastener such as a screw or a nail is removed, the impact waveform in idle driving is recognized in the memory part 48 or the ROM 58, and in case that the idle driving has been continuously produced several times, the light emitting part 62 is blinked. By such the operation, the accumulative actual driving number of the pneumatic tool 10A is read out from the tool body 12, and displayed in the display part 104 of the information processing unit 100.

Heretofore, in case that the actual driving number and the like are read out from the pneumatic tool 10A, since these information is stored in the storage unit of the tool body 12, a method of confirming the information has been very difficult. Therefore, a method of connecting a jig through a wire to the substrate of the tool body 12 and acquiring the information from the substrate has been also proposed. However, in this case, since the body tool 12 must be disassembled to take out the substrate and then the wire of the jig must be connected to a connector on the substrate, the working is inefficient.

To the contrary, according to the embodiment, by utilizing the light emitting part 62 for giving a warning of the maintenance time of the tool body 12, the maintenance information such as the actual driving number is emitted. Therefore, it is not necessary to disassemble the tool body 12 to take out the control substrate 50A, and the working efficiency can be greatly improved. Hereby, for example, in sales activities of selling a tool to a customer, by bringing the information processing unit 100 to the customer and reading out the maintenance information such as the actual driving number from customer's tool, the tool-parts replacing time can be determined there, which can promote sales of tools.

### Embodiment 3

Next, a case where a power tool 10B is used in place of the above-mentioned pneumatic tool 10A will be described. Components common to the pneumatic tool 10A, the control substrate 50A and the like which have been described in the first embodiment are denoted by the same symbols, and detailed description of them are omitted.

<Configuration of Power Tool>

FIG. 11 shows the block configuration of the power tool 10B according to a third embodiment. The power tool 10B includes a control substrate 50B, a cell 66, a light emitting part 62, a sensor part 64, a motor 70, and a battery 72. The control substrate 50B includes a control part 54 configured by a CPU 56, a ROM 58 and a RAM 60; a memory part 48; a timer part 142; and plural I/F's 68.

The memory part 48 is composed of a nonvolatile semiconductor memory. In the memory part 48, data such as the maintenance time, the number of actual driving, and the number of oil filling are stored. The data becomes a criterion for giving warning for the motor current-carrying time of the power tool 10B and for the maintenance time of the power tool 10B.

The motor 70 is connected through the I/F 68 to the control part 54. The motor 70 supplies the control part 54 a drive signal generated when rotational drive of the motor 70 is started by the trigger operation. The motor 70 supplies the control part 54 a stop signal generated when the rotational drive of the motor 70 is stopped. The motor 54 supplies the timer part 142 control signals respectively based on the drive signal and the stop signal supplied from the motor 70.

The timer part 142 counts the motor current-carrying time based on the control signals supplied from the control part 54. The counted motor current-carrying time is added to the motor current-carrying time already stored in the memory part 48, and stored again in the memory part 48. Namely, in the memory part 48, the accumulative motor current-carrying time is stored.

The battery 72 is connected through the I/F 68 to the control part 54 and the motor 70. The control part 54 counts the replacement number of the battery 72 with the operation in the attachment time of the battery 72 to the power tool 10B or in the detachment time of the battery 72 from the power tool 10B as a trigger.

The motor 70 is incorporated in the inside of a not-shown housing of the power tool 10B. When the trigger is pulled, the motor 70 is actuated, and a driver bit is rotated by the motor 70 through a rotational drive transmitting part, whereby the screw fastening operation is performed.

<Operation of Power Tool>

Next, an example of the operation in case that warning for the maintenance time of the power tool 10B is given will be described. FIG. 12 is a flowchart showing the operation of the power tool 10B.

In a step 100, the control part 54 detects the ON-operation of the motor. The control part 54 detects the ON-state of the motor based on the drive signal supplied from the motor 70, and supplies a control signal based on the drive of the motor 70 to the timer part 142. In a step S110, the timer part 142, based on the control signal supplied from the control part 54, starts to count the motor current-carrying time and the control part 54 proceeds to a step S120.

In the step S120, the control part 54 detects a detection signal based on actual driving of the power tool 10B which has been supplied from the sensor part 64, and proceeds to a step S130. In the step S130, the control part 54 updates the actual driving number previously stored in the memory part 48. Upon completion of the update of the actual driving number, the control part proceeds to a step S140. In the step S140, the control part 54 updates the motor current-carrying time. The detailed operation of this processing will be described later.

In a step S150, the control part 54 compares the accumulative actual driving number with the previously set oil-filling number, and determines whether the accumulative actual driving number exceeds the oil-filling number or not. In case that the control part 54 had determined that the accumulative actual driving number exceeds the oil-filling number, the control part 54 performs processing in the steps S32 to S38 shown in FIG. 5. On the other hand, in case that the control part 54 had determined that the accumulative actual driving number is below the oil-filling number, the control part 54 proceeds to a step S160.

In the step S160, the control part 54 compares the accumulative actual driving number with the previously set maintenance number, and determines whether the accumulative actual driving number exceeds the oil-filling number or not. In case that the accumulative actual driving number has exceeded the maintenance number, the control part 54 performs processing in the steps S42 to S48 shown in FIG. 6. On the other hand, in case that the accumulative actual driving number is below the maintenance number, the control part 54 proceeds to a step S170.

In the step S170, the control part 54 compares the motor current-carrying time with the previously set maintenance time, and determines whether the motor current-carrying time exceeds the maintenance time or not. The control part 54 reads out the updated motor current-carrying time and the previously stored maintenance time (threshold) from the memory part 48, and compares the motor current-carrying time with the maintenance time. The control part 54, in case that it has determined that the motor current-carrying time exceeds the maintenance time, proceeds to a step S172 shown in FIG. 13, and, in case that it has determined that the motor current-carrying time is below the maintenance time, returns to the step S100.

FIG. 13 is a flowchart showing the operation of the power tool 10B in case that warning of the maintenance time is given. In the step S172, the control part 54, in case that it has determined that the motor current-carrying time exceeds the maintenance time, performs warning processing of warning the user that the maintenance operation is required. In the warning processing, the control part 54 supplies a control signal for light emission and blink to the light emitting part 62 and blinks the light emitting part 62 at the predetermined pattern.

In a step S174, the control part 54 compares “the motor current-carrying time” with “the maintenance time+ten times”, and determines whether “the motor current-carrying time” exceeds “the maintenance time+10 times” or not. Hereby, for only the time of “+10 times” since the motor current-carrying time came to “the maintenance time”, the light emitting part 62 blinks. Therefore, the user can notice surely the warning by the light emitting part 62 for this time. The control part 54, in case that it has determined that “the motor current-carrying time” exceeds “the maintenance time+10 times”, proceeds to a step S176. On the other hand, the control part 54, in case that it has determined that “the motor current-carrying time” is below “the maintenance time+10 times”, returns to the step S100.

In the step S176, the control part 54 updates a numerical value of the maintenance time. The control part 54, after updating the numerical value of the maintenance time, proceeds to a step S178.

In the step S178, the control part 54 performs warning release processing. In the warning release processing, the control part 54, after blinking the light emitting part 62 for only the predetermined time, stops the blink of the light emitting part 62. Upon completion of the warning release processing, the control part 54 returns to the step S100. By such the operation of the control part 54, the light emitting part 62 is blinked to give the warning when the motor current-carrying time has come to the specified maintenance time. Therefore, the user can grasp accurately the maintenance time.

FIG. 14 is a flowchart showing the detailed operations in the above-mentioned steps S110 and S140. In a step S200, the timer part 142, when detecting power-application to the motor, adds a motor current-carrying time M_time. In a step S210, the control part 54 determines whether or not the added motor current-carrying time M_time passes the predetermined update time, that is, 60 seconds in this example.

In a step S220, the control part 54, in case that it has determined that the motor current-carrying time M_time passes the predetermined update time, reads out a motor total current-carrying time Total_M_time from the memory part 48. The control part 54 makes an addition to the motor total current-carrying time Total_M time in a step S230, and updates the motor total current-carrying time Total_M_time stored in the memory part 48 in a step S240.

As described above, according to the third embodiment, similarly to the case in the first embodiment, when the accumulative actual number of the power tool 10B has come to the previously set maintenance number or oil-filling time, or when the motor current-carrying time has come to the maintenance time, the light emitting part 62 performs blinking light-emission, whereby it is warned that the power tool 10B is into the maintenance time. Therefore, the user can grasp surely and accurately the maintenance time of the tool. Hereby, passing of the maintenance time can be prevented, and expansion of the parts broken portion can be prevented by repairing the parts in advance.

### Embodiment 4

<Configuration of Management System>

FIG. 15 shows the configuration of a management system 300 according to fourth embodiment of the invention. The management system 300 manages specific information of a pneumatic tool 10C by terminal units 152, 156, 162 and 192, and host devices 158, 164 and 194 respectively set in a factory 150, a store 154, a sales center 160 and a repair center 190.

The terminal units 152, 156, 162 and 192 read out specific information from a control substrate 50C of the pneumatic tool 10C and display its information. Alternatively, the terminal units 152, 156, 162 and 192 write specific information into the control substrate 50C of the pneumatic tool 10C by the input operation. The terminal units 152, 156, 162 and 192 function also as relay terminals when communication is performed between the pneumatic tool 10C and the host devices 158, 164 and 194.

The host devices 158, 164 and 194, which show an example of an information processing unit, read out specific information from the pneumatic tool 10C thereby to store its information in databases 159, 165 and 195, or write specific information into the pneumatic tool 10C.

In the factory 150, the terminal unit 152 is installed. The terminal unit 152 stores, in the control substrate 50C (storage part) of the pneumatic tool 10C, a specific manufacture serial number assigned to the pneumatic tool 10C manufactured in the factory.

In the store 154, the terminal unit 156 and the host device 158 are installed. The terminal unit 156 stores a purchase date of the pneumatic tool 10C and the like in the control substrate 50C of the pneumatic tool 10C. The host device 158, which is connected to the terminal unit 156, stores the specific information such as the purchase date supplied form the terminal unit 156 in the database 159.

In the sales center 160, the terminal unit 162 and the host device 164 are installed. In the terminal unit 162, specific information relating to the pneumatic tool 10C such as customer information acquired by a sales person is inputted. The host device 164, which is connected to the terminal unit 162, stores the specific information such as the customer information transmitted from the terminal unit 162 in the database 165.

In the repair center 190, the terminal unit 192 and the host device 194 are installed. The terminal unit 192 reads out, from the control substrate 50C of the pneumatic tool 10C delivered from the customer, usage information of the pneumatic tool 10C and stores the read-out usage information in a storage part (refer to FIG. 17). The terminal unit 192 stores repair information when the pneumatic tool 10C has been repaired in the control substrate 50C of the pneumatic tool 10C. The host device 194, which is connected to the terminal unit 192, stores the specific information of the pneumatic tool 10C such as the usage information transmitted from the terminal unit 192 in the database 195.

The host device 164 of the sales center 160 and the host device 194 of the repair center 190 are interconnected through a network 220, and they enable bidirectional communication of data such as the specific information stored in each database 165, 195.

The terminal units 152, 156, 162 and 192 have respectively the same configuration, and the host devices 158, 164 and 194 have also the same configuration respectively. Therefore, in the following example, only the terminal unit 162 and the host device 164 in the sales center 160 will be described.

Since the pneumatic tool 10C used in the management system 300 has the same configuration as the configuration of the pneumatic tool 10C in the first embodiment, the description of the pneumatic tool 10C is omitted. Further, since the control substrate 50C provided for the pneumatic tool 10C used in the fourth embodiment has also the same configuration as the configuration of the control substrate 50A in the first embodiment, the description of the control substrate 50C is omitted.

Next, the block configuration of the pneumatic tool 10C provided with the control substrate 50C will be described. FIG. 18 shows the block configuration of the pneumatic tool 10C. To a communication part 69, the terminal unit 162 is connected. Since other configuration is the same as that of the pneumatic tool 10C in the first embodiment, its description is omitted.

<Configuration of Terminal Unit>

Next, the configuration of the terminal unit 162 for reading out, from the control substrate 50C of the above-mentioned pneumatic tool 10C, specific information of the pneumatic tool 10C will be described. FIG. 19 is a perspective view showing a configuration example of the terminal unit 162. Since the terminal unit 162 has the similar configuration to the configuration of the information processing unit 100 in the first embodiment, the description of common members is omitted.

Into a not-shown upper outlet of a unit body 102 of the terminal unit 162, a connector 128 on one end side of a cable 126 is inserted, and a connector 127 on the other end thereof is connected to a communication part 69 of the not-shown control substrate 50C.

Next, the block configuration of the terminal unit 162 will be described. FIG. 20 shows the block configuration of the terminal unit 162. To a bus 137, a control part 130, an operational part 118, a display part 104, and communication parts 138 and 139 are connected respectively. To the communication part 139, which is an example of a first communication part, the pneumatic tool 10C is connected through the cable 126 (refer to FIG. 23). To the communication part 138, which is an example of a second communication part, the host device 164 is connected through a cable 230 (refer to FIG. 23).

The operational part 118, which is an input unit for inputting the specific information relating to the pneumatic tool 10C, generates an operational signal based on the specific information inputted by user's operation, and supplies the generated operational signal to the control part 130.

The control part 130 is composed of a CPU 132, a ROM 134, and a RAM 136. The control part 130 supplies the specific information based on the operation signal supplied from the operational part 118 through the communication part 139 to a memory part 48 of the pneumatic tool 10C. Further, the control part 130, by an instruction from the operational part 118, reads out the specific information from the memory part 48 of the pneumatic tool 10C through the communication part 139, and generates an image signal based on the read-out specific information to supply the image signal to the display part 104. Further, the control part 130 supplies the specific information read out through the communication part 139 from the memory part 48 of the pneumatic tool 10C through the communication part 138 to the host device 164.

The display part 104 displays on a screen an image based on the image signal supplied from the control part 130. On the screen, for example, the specific information of the pneumatic tool 10C such as the accumulative actual driving number and a manufacture serial number is displayed.

<Configuration of Host Device>

Next, the block configuration of the host device 164 will be described. FIG. 21 shows an example of the block configuration of the host device 164. Since other host devices; the host device 158 in the store 154 and the host device 194 in the repair center 190 have the same configuration as the configuration of the host device 164 in the sales center 160, the description of them is omitted.

The host device 164 is composed of, for example, a personal computer, and includes an operational part 178, a display part 180, a control part 166, a storage part 182, a communication part 174, and a communication interface (communication I/F) 176.

The operational part 178, which is an input unit for inputting the specific information relating to the pneumatic tool 10C, is composed of, for example, a mouse and a keyboard. The operational part 178 generates an operational signal based on the specific information inputted by user's operation, and supplies the generated operational signal to the control part 166.

The display part 180 is composed of, for example, a liquid crystal display or an organic EL display. The display part 180 displays the database 165 read out from the storage part 182 by an instruction from the control part 166, or displays various information such as image data transmitted through the network 220.

The control part 166 is composed of a CPU 168, a ROM 170 and a RAM 172. The ROM 170 stores a program used by the CPU 168 and an arithmetic parameter. The RAM 172 stores and holds temporarily the data obtained when the CPU performs various processing, and is mainly used as a working area of the various processing. The CPU 168 executes the program stored in the ROM 170.

The control part 166 supplies the specific information inputted by the operational part 178 through the communication part 174 and the terminal unit 162 to the memory part 48 of the pneumatic tool 10C. Further, the control part 166 reads out the specific information through the communication part 174 from the memory part 48 of the pneumatic tool 10C based on the operation signal from the operational part 178, and supplies the read-out specific information to the memory part 182.

The storage part 182 is composed of a semiconductor memory such as a Hard Disc Drive (HDD) or a flash memory, and includes the database 165 which stores therein the specific information of the pneumatic tool 10C. The storage part 182 stores in the database 165, by an instruction of the control part 80, the specific information of the pneumatic tool 10C read out from the memory part 48 of the pneumatic tool 10C or from another host device 194, and updates the specific information stored in the database 165 every time specific information is supplied. The configuration of the database 165 will be described later.

The communication part 174, which is used for connecting, for example, the terminal unit 162 or another external peripheral equipment to the host device 164, includes a connection terminal such as USB or IEEE1394. The communication part 174 may be configured by wireless communication such as Bluetooth® and 802.11 a/b/g.

The communication interface (communication I/F) 176 is composed of a communication device for connecting to the network 220. The communication I/F 176 performs transmission and reception of various data such as the specific information of the pneumatic tool 10C with, for example, the host device 194 in the repair center 190. This communication I/F 176 corresponds to wire communication such as Ethernet® and wireless communication such as 802.11 a/b/g.

FIG. 22 is an example of the configuration of the database 165 stored in the host device 164. In the database 165, information such as a customer number 400, a customer name 402, a manufacture serial number 404, a purchase date 406, repair information 408 and tool usage information 416 are stored in connection with, for example, the customer number 400. The repair information 408 includes a repair date 410, repair contents 412 and a replacement part 414. The tool usage information 416 includes the actual driving number 418, motor current-carrying time 420 and the battery replacing number 422.

The customer number 400 is a specific identification number assigned to a user who has purchased the pneumatic tool 10C. The customer name 402 is a name of the user who has purchased the pneumatic tool 10C. The manufacture serial number 404 is a specific identification number assigned to the purchased pneumatic tool 10C. The purchase date 406 is the date when the user has purchased the pneumatic tool 10C.

The repair date 410 is the date when the pneumatic tool 10C has been delivered to the repair center 190 and repaired there. The repair contents 412 are processing contents in repair of the broken portion of the pneumatic tool 10C. The replacement part 414 is a name of a part replaced in the repair. The actual driving number 418 is the accumulative actual driving number at which the pneumatic tool 10C has actually driven fastener. The motor current-carrying time 420 is the time for which the motor is driving. The battery replacement number 422 is the number at which the battery has been replaced due to a breakdown.

<Example of Connection Among Control Substrate, Terminal Unit and Host Device>

Next, connection among the control substrate 50C of the above-mentioned pneumatic tool 10C, the terminal unit 162 and the host device 164 will be described. FIG. 23 explains an example of configuration in connection among the control substrate 50C of the pneumatic tool 10C, the terminal unit 162 and the host device 164. In FIG. 23, the tool body 12 of the pneumatic tool 10C is omitted.

The terminal unit 162 is electrically connected to the control substrate 50C of the pneumatic tool 10C through the cable. The connector 127 on one end side of the cable 126 is connected to the communication part 69 of the control substrate 50C, and the connector 128 on the other end side of the cable 126 is connected to the communication part 138 of the terminal unit 162.

The terminal unit 162 is electrically connected to the host device 164 through the cable 230. A connector 232 on one end side of the cable 230 is connected to the communication part 139 of the terminal unit 162, and a connector 324 on the other end side of the cable 230 is connected to the communication part 174 of the host device 164.

Thus, by using the terminal unit 162 as a relay equipment, it is possible connect the host device 164 to the pneumatic tool 10C, and to read out the specific information from the memory part 48 of the pneumatic tool 10C thereby to store the specific information in the database 165. Further, in case that the terminal unit 162 is alone used in the sales destination, only the host device 164 should be connected to the pneumatic tool 10C.

<Operation of Management System>

FIG. 24 is a flowchart showing an example of the operation of the management system 300. In a step S300, the terminal unit 152 in the factory 150 stores, in a memory part 48 of a control substrate 50C before being mounted on a pneumatic tool 10C, a manufacture serial number of the pneumatic tool 10C. Thereafter, the control substrate 50C is mounted on the pneumatic tool 10C, and the pneumatic tool 10C on which the control substrate 50C has been mounted is delivered to the store 154.

In a step S310, the terminal unit 156 of the store 154, when the pneumatic tool 10C is sold to a customer, stores a purchase date of the pneumatic tool 10C and a customer number in the memory part 48 of the pneumatic tool 10C. Further, the host device 158 reads out the manufacture serial number of the pneumatic tool 10C from the memory part 48 of the pneumatic tool 10C through the terminal unit 156 and stores the read-out manufacture serial number in the database 159.

In a step S320, in the store 154, a customer registration card in which a customer who has purchased the pneumatic tool 10C has written data is sent to the sales center 160. In the customer registration card, for example, a customer number of the customer who has purchased the pneumatic tool 10C, and a purchase date of the pneumatic tool 10C are described. In the sales center 160, the customer number and purchase date described in the customer registration card sent from the store 154 are inputted in the host device 164 by operating the operational part 178. The host device 164 stores the inputted customer number and purchase date in the database 165.

In the step S330, in the sales center 160, customer information relating to the customer which a sales person has acquired directly in a customer company or in a workplace is stored in the database 165 of the host device 164. The customer information includes, for example, a customer company name and the number of workers in this company.

In a step S340, the breakdown portion of the pneumatic tool 10C delivered to the repair center 190 is repaired. The terminal unit 192 and the host device 194 in the repair center 190 store, in the memory part 48 of the pneumatic tool 10C, repair information of the pneumatic tool 10C obtained by the repair, such as replacement parts. Simultaneously with this operation, the repair center 190 stores the repair information of the pneumatic tool 10C in the database 195 of the repair center 190.

In a step S350, the host device 194 of the repair center 190 reads out the tool usage information such as the actual driving number from the memory part 58 of the pneumatic tool 10C which the repair center has been requested to repair. Thereafter, the host device 194 stores the read-out tool usage information in the database 195.

In a step S360, the host device 194 of the repair center transmits the specific information such as the repair information stored in its own database 195 through the network 220 to the host device 164 of the sales center 160. Namely, the host device 194 transmits to the host device 164 the specific information including the information which has not been registered in the database 165 of the host device 164 in the sales center 160. The host device 164 of the sales center 160 stores in the database 165 the specific information such as the repair information transmitted from the host device 194 of the repair center.

In a step S370, the host device 164 of the sales center 160 transmits the specific information such as the tool usage information stored in its own database 165 through the network 220 to the host device 194 of the repair center 190. Namely, the host device 164 transmits to the host device 194 the specific information including the information which has not been registered in the database 195 of the host device 194 in the repair center 190. The host device 194 of the repair center 190 stores in the database 195 the specific information such as the tool usage information transmitted from the host device 164 of the sales center 160.

Next, the operation of a control part 54 of the pneumatic tool 10C will be described. FIG. 25 is a flowchart showing an example of the operation of the control part 54 of the pneumatic tool 10C. In this embodiment, an example of the operation of writing the specific information into the pneumatic tool 10C and reading out the specific information from the pneumatic tool 10C by the host device 194 of the repair center 190 will be described.

In a step S400, the control part 54 determines whether the terminal unit 192 has been connected to the communication part 69 or not. This connection can be determined by whether the cable 126 has been connected to the communication part 69 or not. The control part 54, in case that it has determined that the terminal unit 192 has been connected to the communication part 69, proceeds to a step S410, and in case that it has determined that the terminal unit 192 has not been connected to the communication part 69, waits till the terminal unit 192 is connected.

In a step S410, the control part 54 determines whether the specific information of the pneumatic tool 10C has been transmitted from the terminal unit 192 or not. Namely, the control part 54 determines whether the terminal unit 192 has requested the memory part 48 to write the specific information or not. The specific information is read out from the database 195 of the host device 194. As the specific information, for example, repair information obtained in repair is transmitted. The control part 54, in case that it has determined that the specific information of the pneumatic tool 10C has been supplied, proceeds to a step S420, and, in case that it has determined that the specific information of the pneumatic tool 10C has not been supplied, proceeds to a step S430.

In the step S420, the control part 54 stores in the memory part 48 the specific information of the pneumatic tool 10C supplied from the terminal unit 192. For example, in case that the specific information is repair information, the control part 54 stores this repair information in the memory part 48.

In the step S430, the control part 54 determines whether a control signal for reading out the specific information stored in the memory part 48 of the pneumatic tool 10C has been transmitted from the terminal unit 192 or not. The host device 194 side can instruct the control part 54 to read out all the specific information stored in the memory part 48, and also a part of the specific information. The control part 54, in case that it has determined that the control signal has been supplied, proceeds to a step S440, and in case that it has determined that the control signal has not been supplied, waits for other instructions.

In the step S440, the control part 54 reads out the specific information from the memory part 48 based on the control signal from the terminal unit 192 and transmits the read-out information through the communication part 69 to the terminal unit 192. The terminal unit 192 receives the specific information through the communication part 139, and supplies the received specific information to the host device 194 connected to the terminal unit 192. The host device 194 stores the specific information supplied from the terminal unit 192 in the database 165.

Thus, by the terminal unit 192 and the host device 194, the specific information can be written into the memory part 48 of the pneumatic tool 10C, or the specific information can be read out from the memory part 48 of the pneumatic tool 10C. Naturally, also by only the terminal unit 192, the specific information can be written into the memory part 48 of the pneumatic tool 10C, or the specific information can be read out from the memory part 48. For example, in case that the sales person gets away from the sales center 160 because of sales, since the terminal unit 192 can be readily carried, the terminal unit 192 can be appropriately used. Further, by the operation shown in FIG. 25, also from the host device 158 of the store 154 or the host device 164 of the sales center 160, the specific information can be written into the memory part 48 of the pneumatic tool 10C, or the specific information can be read out from the memory part 48 from the pneumatic tool 10C.

As described above, according to the embodiment, for example, by reading out the specific information such as the customer number, the customer name, and the manufacture serial number from the pneumatic tool 10C sent to the repair center 190 for repair, the owner of the pneumatic tool 10C can be grasped. Therefore, in case that this pneumatic tool 10C has been provided as theft information for some time, since whether the pneumatic tool 10C is a stolen tool or not can be determined from the read-out specific information, an effect of preventing the theft can be obtained.

Further, by bringing the terminal unit 152, 156, 162 or 192 to the customer and reading the specific information such as the tool usage information and the purchase date directly from customer's pneumatic tool 10C, the sales person can give speedily warning of the repair time or the replacement purchase time of a pneumatic tool 10C. This speedy warning can promote the sale of a pneumatic tool 10C, and enables customer-oriented aftercare and sales activity. Further, from the database 165 of the sales center 160, the sales person can browse the repair information of the pneumatic tool 10C which the customer owns and the tool usage information thereof. Hereby, also from the sales center 160, the sale of a pneumatic tool 10C can be guided for the customer by means of a telephone or a letter, which enables sales promotion of the pneumatic tool 10C.

Since the host device 164 of the sales center 160 and the host device 194 of the repair center 194 are interconnected through the network 220, they have the newest specific information of the pneumatic tool 10C in common.

### Embodiment 5

Next, a case where a power tool 10D is used in place of the above-mention pneumatic tool 10C will be described. Regarding components common to those in the power tool 10B described in the above-mentioned second embodiment, the detailed description is omitted.

To a control part 54, a terminal unit 162 is connected through a communication part 69, and specific information relating to the power tool 10B inputted from the terminal unit 162 or a host device 164 connected to this terminal unit 162 is supplied. The control part 54, based on an instruction from the terminal unit 162, reads out the specific information from a memory part 48, and supplies the read-out specific information through the communication part 69 to the terminal unit 162 or the host device 164 connected to this terminal unit 162.

The memory part 48 is composed of a nonvolatile semiconductor memory, and stores, by an instruction from the control part 54, therein the specific information relating to the power tool 10B inputted from the terminal unit 162 or the host device 164 connected to this terminal unit 162. Further, in the memory part 48, the specific information is stored, such as the motor current-carrying time of the power tool 10B, the replacement number of a buttery 72, a manufacture serial number of a tool body 12, a customer number of a customer who has purchased the tool body 12, a purchase date, and repair information.

As described above, according to the embodiment, the operational advantage similar to that in the above fourth embodiment can be obtained. Namely, since the specific information of the power tool 10D can be acquired from the power tool 10D and each database 159, 165, 195, notice of the repair time of the power tool 10D and sales promotion are enabled, and further an antitheft inhibitory effect can be obtained.

A technical range of the invention is not limited to the above-mentioned embodiments, and includes various modifications added to the above embodiments without departing from the scope of the invention.

In the above fourth and fifth embodiments, thought the terminal unit 152, 156, 162, 192 is connected through the cable 126 to the control substrate 50C, 50D, the invention is not limited to this. For example, by providing wireless communication parts respectively for the control substrate 50C, 50D and the terminal unit 152, 156, 162, 192, the control substrate 50C, 50D and the terminal unit 152, 156, 162, 192 can be also interconnected by wireless communication. Further, by providing light emitting elements and light receiving elements respectively for the terminal unit 152, 156, 162, 192, the pneumatic tool 10C, and the power tool 10D, converting the specific information into a blinking signal to make light emission at the light emitting element, and receiving this blinking signal by the light receiving element, the specific information can be also transmitted and received between the terminal unit and the pneumatic tool 10C or the power tool 10D.

While the invention has been described in detail and with reference to specific embodiments thereof, it would be apparent to those skilled in the art that various changes and modifications may be made therein without departing from the spirit and the scope of the invention.

The invention is based on Japanese Patent Application No. 2008-132313, filed on May 20, 2008 and Japanese Patent Application No. 2008-132314, filed on May 20, 2008, the entire contents of which are herein incorporated by reference.

### INDUSTRIAL APPLICABILITY

The invention can be applied to a tool capable of acquiring readily the maintenance time and specific information.

1. A tool comprising:
detector which detects maintenance information used in determination of the maintenance time of a tool body;
a controller which determines, based on a comparison result between the maintenance information detected by the detector and basic maintenance information set in advance, whether the tool body is into the maintenance time or not; and
a notifier which notifies the user that the tool body is into the maintenance time in case that the controller has determined that the tool body is into the maintenance time.

2. The tool according to claim 1 further comprising:
a storage part which stores the maintenance information detected by the detector, wherein
the controller, every time the maintenance information is detected by the detector, makes an addition to the maintenance information stored in the storage part and updates the maintenance information.

3. The tool according to claim 1 or 2, wherein: the tool body is a compressed air driving tool which drives a fastener by reciprocating a driving mechanism by the compressed air;
the maintenance information is the number of actual driving of the compressed air driving tool;
the basic maintenance information is the actual driving number corresponding to the part-replacing time of the compressed air driving tool, or the number of oil filling corresponding to the oil-filling time of the compressed air driving tool; and
the detector is constituted by an impact sensor which detects the actual driving number of the compressed air driving tool or an acceleration sensor.

4. The tool according to claim 3, wherein:
the tool body includes a housing part which accommodates the impact sensor or acceleration sensor; and
the impact sensor or the acceleration sensor is accommodated in the housing part so that a flat surface of the sensor becomes vertical to a driving direction of the fastener.

5. The tool according to claim 1, wherein:
the tool body is a power tool which drives a fastener by reciprocating a driver of a driving mechanism by a motor;
the maintenance information is the current-carrying time of the motor;
the basic maintenance information is the motor current-carrying time corresponding to the part-replacing time of the power tool; and
the power tool includes further a timer part which counts the current-carrying time of the motor.

6. An information processing unit comprising:
a detector which detects maintenance information used in determination of maintenance time of a tool body;
a tool controller which determines, based on a comparison result between the maintenance information detected by the detector and basic maintenance information set in advance, whether the tool body is into the maintenance time or not:
a notifier which notifies a user that the tool body is into the maintenance time in case that the tool controller has determined that the tool body is into the maintenance time;
a light receiving part which receives the light emission signal emitted from the light emitting means;
an information processing controller which decodes the light emission signal received by the light receiving signal and generates an image signal based on the maintenance information; and
a display part which displays the maintenance information on a screen based on the image signal generated by the information processing controller,
wherein the notifier acquires the maintenance information from a tool constituted by a light emitting means which emits the maintenance information as a light emission signal.

7. A tool in which specific information of a tool body is managed by an information processing unit, comprising:
a communication part for performing communication with the information processing unit;
a control part which obtains the specific information of the tool body inputted through the communication part from the information processing unit; and
a storage part which stores the specific information of the tool body obtained by the control part,
wherein the specific information is read out by the information processing unit through the communication part from the storage part of the tool body.

8. The tool according to claim 7, wherein the storage part stores tool usage information relating to usage of the tool body.

9. The tool according to claim 8 further comprising:
a sensor part which detects driving information when the tool body performs driving for a member to be driven,
wherein the control part counts the actual driving number of the tool body based on the driving information detected by the sensor part, and stores the counted actual driving number in the storage part as the specific information.

10. The tool according to claim 7 or 8, wherein:
the tool body is a power tool which drives a fastener by reciprocating a driver of a driving mechanism by a motor;
the tool body includes a sensor part which detects current-carrying information of the motor; and
the control part counts the current-carrying time of the motor based on the current-carrying information detected by the sensor part, and stores the counted current-carrying time in the storage part as the specific information.

11. A terminal unit for managing specific information of a tool, comprising:
a first communication part for performing communication with the tool;
a control part which reads out the specific information through the first communication part from the storage part of the tool; and
a display part which displays the specific information read out from the control part.

12. The terminal unit according to claim 11 further comprising:
a second communication part for connecting the information processing unit,
wherein the control part supplies the specific information read out from the storage part of the tool through the first communication part to the information processing unit through the second communication part.

13. The terminal unit according to claim 11 or 12 further comprising:
an operational part for inputting the specific information of the tool,
wherein the control part supplies the specific information inputted by the operational part to the storage part of the tool through the first communication part.

14. A management system which manages specific information of a tool by an information processing unit, wherein:
the tool includes a communication part which performs communication with the information processing unit and another information processing unit, a control part which obtains the specific information of the tool inputted through the communication part from the information processing unit and/or another information processing unit, and a storage part which stores the specific information of the tool obtained by the control part; and
the information processing unit includes a communication part which performs communication with the tool, a control part which reads out the specific information of the tool through the communication part from the storage part of the tool, and a storage part having a database which stores the specific information of the tool read out by the control part.

15. The management system according to claim 14, wherein the specific information of the tool includes at least one or more of a customer number of a customer who owns the tool, a customer name, a purchase date of the tool, repair information obtained when the tool has been repaired, and usage information of the tool.

16. The management system according to claim 15, wherein the tool repair information includes at least one or more of a repair completion date of the tool, repair contents of the tool, and a replacement component which has been replaced in the repairing time.

17. The management system according to claim 15, wherein the tool usage information includes at least one or more of the actual driving number of the tool, motor current-carrying time of the tool, and the battery replacement number of the tool.
